(19) United States
(12) Patent Application Publication
(10) Pub. No.: US 2009/0252259 A1
(43) Pub. Date: Oct. 8, 2009

(54) RECEIVING DEVICE AND RECEIVING METHOD

(75) Inventor: Masayuki Ikeda, Shiojin-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/238,250

(22) Filed: Sep. 25, 2008

(30) Foreign Application Priority Data
Sep. 27, 2007 (JP) 2007-250777

(51) Int. Cl. H04L 27/06

(52) U.S. Cl. 375/340

(57) ABSTRACT

A receiving device that receives as a received signal R^{→} a transmission signal T^{→} (T^{→}=a₁e₁^{→}+a₂e₂^{→}+ . . . +aₖeₖ^{→}) obtained by multiplying k (k is a positive integer) linear independent signal vectors {eᵢ^{→}|i is an integer satisfying 1≦i≦k} by a transmission information coefficient {ai|i is an integer satisfying 1≦i≦k and ai is a real number} is disclosed. The receiving device includes: a template generating unit that generates m (m is a positive integer) linear independent template vectors {pᵢ^{→}|1≦i≦m}; a correlation unit that calculates a correlation value {ci=(R^{→},pᵢ^{→})|1≦i≦m} between the received signal R^{→} and the template vector {pᵢ^{→}} and outputs a correlation value vector c^{→} (c₁, c2, . . . , cₘ); and a multiplying unit that multiplies a transposed matrix of a matrix [ρ_{τ}] by the correlation value vector c^{→}. The matrix [ρ_{τ}] converts a matrix [p] of the m template vectors {pᵢ^{→}} into a matrix [eτ] of signal vectors {e_{iτ}^{→}|1≦i≦m} that are obtained by shifting m signal vectors {eᵢ^{→}|1≦i≦m}, which are obtained by adding (m−k) linear independent signal vectors {eᵢ^{→}|k+1≦i≦m} to the signal vectors {eᵢ^{→}}, by a time τ.

### BACKGROUND

1. Technical Field

The present invention relates to a receiving device and a receiving method during communication, and more particularly, to a receiving device and a receiving method effective for a UWB (ultra wide band) communication system using an impulse.

2. Related Art

UWB communication uses a very wide frequency band to transmit a large amount of data at a high speed. As a communication system using a wide-band signal, for example, there are a system using spectral diffusion and an orthogonal frequency division multiplexing (OFDM) system. The UWB communication system is a wide band communication system using pulses having a very small width, and is called an impulse radio (IR) communication system. The IR communication system can perform modulation or demodulation only by operating the time axis, unlike the existing modulation method, which makes it possible to simplify the structure of a circuit or reduce power consumption (see U.S. Pat. No. 6,421,389 and U.S. Published Application Nos. 2003/0108133A1 and 2001/0033576).

FIG. 17 is a block diagram illustrating the typical structure of IR UWB transmitting and receiving devices according to the related art, and FIGS. 18A to 18H are timing charts illustrating the outline of the operations of the IR UWB transmitting and receiving devices. Transmission data is input to a terminal 1001. A pulse generating circuit 1002 generates a wide band pulse. The pulse generating circuit 1002 receives the transmission data signal input to the terminal 1001, and performs predetermined modulation on the generated pulse. For example, a pulse position modulation (PPM) method of shifting the generation position of a pulse or a bi-phase modulation (BPM) method of reversing the polarity of the generated pulse is used as the modulation method. The waveforms of the PPM and BPM methods are shown in FIGS. 18A and 18F, respectively. In the drawings, a solid line and a dashed line indicate bits 1 and 0, respectively. The pulses generated and modulated in this way are radiated to a space by a transmitting antenna 1003.

Next, the outline of the typical structure of the receiving device according to the related art will be described. A signal is received by a receiving antenna 1004, and the received signal is amplified by a low noise amplifying circuit (LNA) 1005 and then transmitted to multiplying circuits 1006 and 1007. At that time, for example, an equalizing process for removing distortion occurring in a transmission path is performed. Examples of the distortion include distortion due to multiple paths and a frequency shift due to the Doppler effect.

The correlation between the received signal that has been amplified by the LNA 1005 and a template pulse generated by a template pulse generating circuit 1008 or 1009 is calculated by a correlator including a multiplying circuit 1006 and an integrating circuit 1010 or a correlator including a multiplying circuit 1007 and an integrating circuit 1011. The correlation results are output from the integrating circuits 1010 and 1011, and a determining circuit 1012 determines the received bit information on the basis of the correlation results to demodulate the bit information. Then, the demodulated information is output from a terminal 1013.

FIGS. 18A to 18H are timing charts illustrating the outline of the operations of the transmitting and receiving devices. FIGS. 18A to 18E show the PPM, and FIGS. 18F to 18H show the BPM.

FIG. 18A shows the received signal that is received by the antenna 1004 and then amplified by the LNA 1005. In the following description, a solid line indicates a bit 1 and a dashed line indicates a bit 0. The template pulse generating circuits 1008 and 1009 generate template pulses of bits 1 and 0, respectively. The template pulse of the bit 1 shown in FIG. 18B is generated by the template pulse generating circuit 1008, and the template pulse of the bit 0 shown in FIG. 18C is generated by the template pulse generating circuit 1009. The multiplying circuits 1006 and 1007 multiply the template pulses by the received signal and output the waveforms shown in FIGS. 18D and 18E (in FIGS. 18D and 18E, a solid line indicates a bit 1 and a dashed line indicates a bit 0). The integrating circuits 1010 and 1011 integrate the two waveforms to remove a high-frequency component, and the integrated waveforms are input to the determining circuit 1012. The determining circuit 1012 compares the correlation values of the waveforms and determines the waveform having a larger correlation value as the transmitted information.

This receiving method of calculating the correlation between the template pulse and the received signal and demodulating the signal is generally called a synchronous detection method. In the synchronous detection method, the timing of the template pulse should be completely matched with the timing of the received signal. For this reason, generally, the synchronous detection method requires synchronization acquisition and synchronization tracking.

The synchronization acquisition means an operation of matching the timing of the transmission device with the timing of the receiving device at the beginning. In many cases, the transmitting device transmits a synchronization signal before transmitting information, and the receiving device establishes synchronization with the synchronization signal. The synchronization tracking means an operation of minimizing timing deviation while information is being received so as to maintain the timings matched by the synchronization acquisition. In the related art described herein, the synchronization tracking is to adjust the timing when the template generating circuit generates the template pulse such that a maximum correlation value is obtained at all times on the basis of the determination result by the determining circuit 1012. This operation is generally not easy to perform. However, in recent years, with the development of a device technique or a digital signal processing technique, this operation has been stably performed even in a high frequency environment.

FIGS. 18F to 18H are timing charts illustrating the outline of the BPM operation. The multiplying circuit 1006 multiplies the received signal (FIG. 18F) by a template pulse (FIG. 18G) generated by the template generating circuit 1008 to form the waveform shown in FIG. 18H. The integrating circuit 1010 removes a high-frequency component from the waveform, and the determining circuit 1012 determines whether the waveform is negative or positive, thereby determining whether the received bit information is 1 or 0.

The template generating circuit 1009, the multiplying circuit 1007, and the integrating circuit 1011 are not described above, but are used for synchronization tracking in many cases. That is, the template generating circuit 1009 generates a template pulse having a small correlation value (absolute value) (ideally, 0) with the template pulse generated by the template pulse generating circuit 1008, and the multiplying circuit 1007 and the integrating circuit 1011 calculate the correlation between the template pulse and the received signal. When the correlation value (absolute value) is the minimum, the correlation value (absolute value) calculated by the multiplying circuit 1006 and the integrating circuit 1010 becomes the maximum. Therefore, it is preferable to adjust the timing when the template pulse is generated such that the integrating circuit 1011 outputs a minimum value (absolute value) at all times. BPM may be performed on the template pulse generated by the template pulse generating circuit 1009. This corresponds to quadrature amplitude modulation (QPSK) in the narrow band communication system according to the related art. The synchronization acquisition and the synchronization tracking are important in the BPM. When there is any unstable factor in the BPM operation, communication quality is significantly deteriorated. In addition, the receiving performance of a receiving device is greatly affected by the accuracy (symmetry and capability of maintaining correlation at a small value (orthogonality)) of the template pulses generated by the two template pulse generating circuits. Therefore, many studies have been conducted on the synchronization acquisition and the synchronization tracking. For example, JP-A-2006-165924 (synchronization tracking), JP-A-2006-211034 (synchronization acquisition), and JP-T-2006-519567 (synchronization acquisition) disclose the synchronization of a receiving device for receiving a UWB signal, but they all require high-precision circuit elements and complicated procedures. Therefore, the structures thereof are complicated.

Low pass filters (LPF) may be used for the integrating circuits 1010 and 1011. In this case, an operation for correlation is substantially the same as described above.

It is also possible to analyze or process a general signal, not the UWB signal, considering the signal as a vector indicating the position of one point on an n-dimensional (n is an integer or infinity) space. The invention is described using this method. This method can be clearly understood by those skilled in the art, but this method according to the related art will be described below for clarity of description.

Numbers in parentheses indicate a vector, which is a quantity specified by a magnitude and a direction. As shown in FIG. 19, a signal waveform S1101 is sampled at a time interval of ΔT in a section T to obtain n (=T/ΔT) sampling values s₁ s₂ . . . sₙ. The sampling values in the parentheses (s₁ s₂ . . . sₙ) are a vector. Since n numbers are arranged, an n-dimensional vector is formed, which indicates coordinates in an n-dimensional space. Now, this is represented by s^{→} (s^{→}=(s₁ s₂ . . . sₙ). Hereinafter, when the vector s^{→} specifies a point, the vector is represented by a point S (or S (s₁ s₂ . . . sₙ)). However, the vector s^{→} may indicate a signal or serve as a position vector indicating a position. Therefore, when the vector s^{→} is not particularly specified, it is simply represented by a ‘signal s^{→}’ or a ‘point s^{→}’.

The inner product of the vector s^{→} is represented by Expression 1 given below.

(s^{→}, s^{→})=s₁²+s₂²+ . . . +sₙ² (1)

The inner product indicates the magnitude of the vector, and the square root thereof indicates the distance between the point S and the origin O in an n-dimensional space. The quantity thereof is referred to as the norm of the vector or the absolute value thereof (|s^{→}|). A value obtained by multiplying the inner product (s^{→}, s^{→}) of the vector by ΔT indicates the energy of a signal. In addition, according to custom, ‘,’ is used as the break character of a component in the parenthesis when representing the inner product of a vector, and a blank is used as the break character of a component in the parenthesis when representing a vector or a matrix.

Two signals S (s^{→}=(s₁ s₂ . . . sₙ)) and R (r^{→}=(r₁ r₂ . . . rₙ)) are considered. The inner product of the two signals is represented by Expression 2 given below.

(s^{→}, r^{→})=(s₁r₁+s₂r₂+ . . . +sₙrₙ) (2)

The inner product of the two signals indicates a quantity related to ∠ROS in a triangle OSR formed by the two vectors s^{→} and r^{→}. Actually, when ∠ROS=α, the inner product of the two signals is represented by Expression 3 given below.

(s^{→}, r^{→})=|s^{→}||r^{→}|cos α (3)

It is possible to know to what extent the two vectors point the same direction by finding α using the above-mentioned method. This is called correlation (or s^{→}, r^{→})/|s^{→}||r^{→}| is called a correlation coefficient) in a signal processing field or statistics. In particular, when α=0° or 180°, the vectors are aligned in the same direction or the opposite direction, and the positive or negative correlation between the vectors are the largest. When α=90°, the inner product (correlation value) of the vectors is 0. Decorrelation is a synonym for the term ‘orthogonal’.

A set of n linear independent vectors can be selected in an n-dimensional space, and an arbitrary vector in the space can be represented by a linear combination thereof. A set of n vectors that have an absolute value of 1 and are orthogonal to each other is called an orthonormal base. When this is represented by e₁^{→}, e₂^{→}, . . . , eₙ^{→}, an arbitrary vector x^{→} can be represented by Expression 4 given below.

x→=(x^{→}, e₁^{→})e₁^{→}+(x^{→}, e₂^{→})e₂^{→}+ . . . +(x^{→}, eₙ^{→})eₙ^{→} (4)

This expression indicates that, when e₁^{→}, e₂^{→}, . . . en^{→} are used as coordinate axes in an n-dimensional space, the coordinates indicating the position of a point x are ((x^{→}, e₁^{→}) (x^{→}, e₂^{→}) . . . (x^{→}, en^{→})). In discrete Fourier series expansion, a set of trigonometrical functions of a period T/an integer i is used as e₁^{→}, e₂^{→}, . . . , eₙ^{→} (where i is an integer satisfying 1≦i≦n).

Now, arbitrary m terms on the right side of Expression 4 are omitted, and the case of approximation with only k terms (=n−m) is considered as the following Expression 5.

x′^{→}=(x^{→}, e₁^{→})e₁^{→}+(x^{→}, e₂^{→})e₂^{→}+ . . . +(x^{→}, eₖ^{→})eₖ^{→} (5)

When x^{→} is approximated to x′^{→} and the coefficient of eᵢ^{→} (where i is an integer satisfying 1≦i≦k) is (x^{→}, eᵢ^{→}) as described above, it has been known that an error |x^{→}−x′^{→}|² (energy error) becomes the minimum.

In the above description, a signal is sampled at a time interval of ΔT to obtain a discrete quantity, but a continuous signal may be treated by the same method as described above. Therefore, the limit of ΔT^{→}0 is considered by reducing ΔT. In this case, an infinity-dimensional space in which n is infinity is considered. In this case, since the inner product defined by Expressions 1 and 2 is divergent, a value obtained by multiplying the inner product by ΔT is considered as the inner product in the continuous signal. In Expression 2, the inner product of two signals s^{→} and r^{→} is defined by Expression 6 given below.

$$( {s}^{\to } , {r}^{\to } ) = {lim}_{Δ T \to ∞} ( {s}_{1} {r}_{1} + {s}_{2} {r}_{2} + … + {s}_{n} {r}_{n} ) Δ T \qquad ( 6 )$$

This is the same as the definition of integration. That is, this is represented by Expression 7 given below.

$$( {s}^{\to } , {r}^{\to } ) = {\int }_{0}^{T} s ( t ) r ( t ) d t \qquad ( 7 )$$

(where s(t) and r(t) indicate continuous functions when the signals S and R are considered as a function of time).

When a signal that is delayed from the signal S by a time τ is s_{τ} and the vector of the signal is s_{τ}^{→} the inner product is calculated according to Expression 2 or Expression 7 by a function ρₛᵣ(τ) of τ, which is called a correlation function and represented by Expression 8 given below.

ρₛᵣ(τ)=(s_{τ}^{→}, r^{→}) (8)

When the signals S and R are the same, the function is called an auto-correlation function. When the signals S and R are different from each other, the function is called a cross correlation function. In addition, the correlation function is used to evaluate the similarity or the periodicity of signals and the width of a pulse in the time axis direction.

The method of processing a UWB communication signal according to the related art will be described considering the above. In the PPM method, one of two signals s₁^{→} and s₀^{→} respectively indicating bits 1 and 0 is selected and transmitted (FIG. 18A). The receiver side generates template pulse signals pᵢ^{→} and p₀^{→} indicating bits 1 and 0 (FIGS. 18B and 18C), and calculates the inner products (correlations) of the received signals s₁^{→} and s₀^{→} and the generated template pulse signals p₁^{→} and p₀^{→}, respectively (FIGS. 18D and 18E). In this case, it is assumed that the transmission signals s₁^{→} and s₀^{→} are transmitted to the receiver side through a transmission path without any distortion. As a matter of course, it is preferable that the signals s₁^{→} and s₀^{→} are similar to the signals p₁^{→} and p₀^{→} in direction, that is, the signals s₁^{→} and s₀^{→} are scalar multiplications of the signals p₁^{→} and p₀^{→} in magnitude (s₁^{→}=ap₁^{→}, and s₀^{→}=ap₀^{→}: a is a scalar). The above description shows that, when the signals s₁^{→} and s₀^{→} are orthogonal to the signals p₁^{→} and p₀^{→}, it is easy to determine the bits 1 and 0.

In the BPM method, a transmitter side reverses the polarity of the signal s^{→} according to a transmission bit 1 or 0 and transmits a signal ±s^{→} (FIG. 18F). A receiver side calculates the inner product (correlation) of a template pulse signal p₁^{→} (FIG. 18G) and the received signal ±s^{→} (FIG. 18H), and determines whether the received signal bit is 1 or 0 on the basis of the calculated result. It is possible to perform synchronization tracking by controlling the correlation with the received signal ±s^{→} to be zero using a template pulse signal p₀^{→} that is orthogonal to the template pulse signal p₁^{→}.

In the two cases, it is premised that the received signals s₁^{→} and s₀^{→} are synchronized with the template pulse signals p₁^{→} and p₀^{→}. Therefore, a control process for synchronization becomes complicated.

The above structure may also be applied to a narrow band communication system according to the related art. FIG. 20 shows bi-phase shift keying (BPSK). That is, a modulation signal (BPSK signal) s^{→} (1102) is generated by reversing the phase of a carrier using data to be transmitted for each 1-bit section Tb. During reception, in order to calculate the inner product (correlation) of the signal and two carriers p_{I}^{→} (1103) and p_{Q}^{→} (1104) that are orthogonal to each other and generated by the receiving device, these are considered as time functions, and the products thereof s(t) p_{I}(t) (1105) or s(t) p_{Q}(t) (1106) are calculated. Then, the waveforms are integrated and the integrated results are used to determine the received data. The frequency and phase of the two carriers p_{I}^{→} (1103) and p_{Q}^{→} (1104) that are generated by the receiving device need to be equal to those of the received signal s^{→} (1102). A phase difference between the two carriers p_{I}^{→} (1103) and p_{Q}^{→} (1104) should be exactly 90°. Therefore, a feedback system, such as a phase locked loop (PLL), is used to maintain the integral value of s(t)p_{Q}(t) (1106), that is, the correlation (the inner product s^{→}, p_{Q}^{→})) between s^{→} and p_{Q}^{→} to be zero at all times.

Quadrature phase shift keying (QPSK) is similar to BPSK except that a transmitter side individually modulates two carriers s_{I}^{→} and s_{Q}^{→}.

Next, the above description is generalized with reference to FIGS. 22 and 23. When k-bit information is transmitted for each symbol, a transmission signal T^{→} of the symbol is represented by Expression 9 given below.

$${T}^{\to } = {a}_{1} {e}_{1}^{\to } + {a}_{2} {e}_{2}^{\to } + … + {a}_{k} {e}_{k}^{\to } = {\sum }_{i = 1}^{k} {a}_{i} {e}_{i}^{\to } \qquad ( 9 )$$

(where a^{→}=(a₁ a₂ . . . aₖ) is a vector indicating information to be transmitted for one symbol, and {eᵢ→|1≦i≦k} indicates a set of template vectors representing bits of one symbol.

When two same signals having different pulse positions are used as e₁^{→} and e₂^{→} to obtain (a₁ a₂)=(1 0) or (a₁ a₂)=(0 1) according to a transmission information bit 1 or 0, this modulation method is the same as the above-mentioned PPM. In addition, when only a single pulse signal e₁^{→} is used to obtain a₁=+1 or −1 according to a transmission information bit 1 or 0, this modulation method is the same as the above-mentioned BPM.

Further, when sine waves having a phase difference of 90° therebetween are used as e₁^{→} and e₂^{→} to obtain a₁ and a₂=+1 or −1 according to a bit of transmission information, this modulation method is the same as the existing QPSK. In this case, {ai} has a value of +1 or 0, but it may have other values (multiple values).

The UWB-IR communication system uses a set of linear independent pulses having very short duration {eᵢ^{→}|1≦i≦k}. JP-A-2003-37638 discloses a structure in which a modified Hermite polynomial is used as {eᵢ^{→}|1≦i≦k}. In addition, JP-T-2003-521143 discloses a PPM method using a Gaussian pulse as {e₁^{→}, e₂^{→}}.

In general, a transmission signal T^{→} can be generated by a circuit that is shown on the left side of FIG. 22. That is, the circuit includes: a transmitting sub-unit 1203 that has a pulse generating circuit 1201 generating e₁^{→} and a multiplying circuit 1202 multiplying the generated signal by a transmission information bit a₁, and generates the product thereof a₁e₁^{→}; a transmitting sub-unit 1204 that has the same structure as the transmitting sub-unit 1203 and generates a₂e₂^{→}; a transmitting sub-unit 1205 that has the same structure as the transmitting sub-unit 1203 and generates aₖeₖ^{→}; and an adding circuit (Σ) 1207 that adds the outputs of the transmitting sub-units 1203 to 1205. The added signal is T^{→}. This signal is transmitted from a transmitting antenna 1206.

The transmitted signal is received by a receiving antenna 1208 of a receiving device and then amplified by a low noise amplifying circuit 1209. In general, the transmission signal T^{→} is distorted while passing through a transmission path, but an equalizing technique is used to remove the distortion. This signal is a received signal R^{→}. A correlation circuit composed of a multiplying circuit 1210 and an integrating circuit 1211 in a receiving sub-unit 1213 calculates the correlation between the received signal R^{→} and a template pulse p₁^{→} generated by a template pulse generating circuit 1212, and a₁ is demodulated. Similarly, a receiving sub-unit 1214 calculates the correlation between the received signal R^{→} and a template pulse p₂^{→}, and a₂ is demodulated. Similarly, a receiving sub-unit 1215 calculates the correlation between the received signal R^{→} and a template pulse pₖ^{→}, and aₖ is demodulated. In this case, it is necessary that components of a set of eᵢ^{→}, that is, {eᵢ^{→}|1≦i≦k} be orthogonal to each other and eᵢ^{→} be equal to pₖ^{→}. Here, { } is a symbol indicating a set, and the form of {*| . . . } is used according to a set theory (where * indicates a source of the set and ‘ . . . ’ indicates the description thereof). It is necessary that the received signal R^{→} be exactly synchronized with {pᵢ^{→}|1≦i≦k}. Therefore, a circuit 1216 evaluates the output of the demodulated result {ai|1≦i≦k} and activates {pᵢ^{→}} such that the output becomes the maximum. In many cases, a feedback system is used.

Expression 9 may be rearranged as follows.

T^{→}=a^{→}[e] (10)

(where T^{→} indicates an n-dimensional row vector, and [e] indicates a k-by-n matrix of n-dimensional row vectors e₁^{→}, e₂^{→}, . . . , eₖ^{→} arranged in this order in the vertical direction (see FIG. 23A, in which a vector is represented by boldface according to custom)).

When the received signal is represented by an n-dimensional row vector R^{→}, the receiving device calculates R^{→t}[p] and demodulates a^{→}. When the transmission signal T^{→} is not distorted and synchronization is established between the transmitting and receiving devices, the received signal is hardly affected by a time delay occurring in the transmission path since [p] is shifted along the time axis by the synchronization. In this case, it is possible to substitute the transmitted signal T^{→} into the received signal R^{→} as follows.

R^{→t}[p]=T^{→t}[p]=a^{→}[e]t[p] (11)

Therefore, when the product [e]^{t}[p] of the matrices is a unitary matrix, a^{→} is accurately demodulated.

In Expression 11, [p] indicates a k-by-n matrix of n-dimensional template row vectors p₁^{→}, p₂^{→}, . . . , pₖ^{→} arranged in this order in the vertical direction, and t[p] indicates a transposed matrix thereof (see FIG. 23B). [e]^{t}[p] can become a unitary matrix when synchronization is established, components of {eᵢ^{→}|1≦i≦k} are orthogonal to each other, and eᵢ^{→} is equal to pᵢ^{→} (1≦i≦k). That is, when the template vector {eᵢ^{→}} of the transmitter side is used as {pᵢ^{→}}, the transmitted data is accurately demodulated.

As described above, demodulation performed by the receiving device is to calculate mapping from an n-dimensional received signal vector to a k-dimensional partial space. In this case, k indicates the number of information bits per symbol of the transmitted signal. In many cases, k is 1. That is, in many cases, mapping from an n-dimensional received signal vector to one dimension indicating an information bit is calculated, and information is extracted from the n-dimensional received signal vector.

A synchronous detection type receiving device has a high receiving performance even when interference, such as cross talk, occurs, but the control process thereof is complicated since the receiving device requires synchronization acquisition and synchronization tracking.

In particular, in the UWB-IR communication system, it is difficult to generate template pulses that are exactly orthogonal to each other since the frequency of a pulse used is as high as a limit frequency of a circuit element, and the timing when the template pulse is generated is delicate.

Further, since the UWB-IR communication system does not use a carrier, signals are intermittently transmitted and received, and feedback loop control for synchronization tracking is intermittently performed.

Furthermore, in many cases, among the signals used in the UWB-IR communication system, the received signal s^{→} does not pass through a partial space including the template pulses p₁^{→} and p₀^{→}. That is, when the transmitting and receiving devices are asynchronous, it is difficult to represent the received signal s^{→} by a linear combination of p₁^{→} and p₀^{→} such that s^{→}=ap₁^{→}+bp₀^{→} is established. This is different from the narrow band communication system according to the related art. That is, as shown in FIG. 21, in the BPSK according to the related art, carriers p_{I}^{→} (1108) and p_{Q}^{→} (1109) generated by the receiving device serve as template vectors, and the received signal is not synchronized with the vectors. Therefore, if there is a phase difference of θ therebetween, there are coefficients a and b that allow the received signal r^{→} (1107) to be exactly r^{→}=ap_{I}^{→}+bp_{Q}^{→} in one bit section Tb. Actually, p_{I}(t)=cos(2πft), p_{Q}(t)=sin(2πft) (where f is a carrier frequency), a signal r(t) having a phase difference of θ from p_{I}(t) is cos(2πft−θ), and cos(2πft−θ)=cos θ cos(2πft)+sin θ sin(2πft). Therefore, when a=cos θ and b=sin θ, r^{→} can be exactly expanded by p_{I}^{→} and p_{Q}^{→}. However, in the UWB-IR communication system in which a transmission signal is a pulse, when a pulse phase is shifted, it is generally difficult to represent the signal by a linear combination of the above-mentioned two simple template vectors. This makes it difficult to calculate the correlation between a received signal and template vectors when a UWB-IR signal is received.

### SUMMARY

An advantage of some aspects of the invention is that provides a receiving device using synchronous detection that can improve a receiving performance even when the accuracy of synchronization and the accuracy of template vectors are lowered, by solving the problems of the synchronous detection of the receiving device according to the related art, particularly, the UWB receiving device.

In order to achieve the above advantage, the following aspects are provided.

### First Aspect

According to a first aspect of the invention, there is provided a receiving device that receives as a received signal R^{→} a transmission signal T^{→} (T^{→}=a₁e₁^{→}+a₂e₂^{→}+ . . . +aₖeₖ^{→}) obtained by multiplying k (k is a positive integer) linear independent signal vectors {eᵢ^{→}|i is an integer satisfying 1≦i≦k} by a transmission information coefficient {ai|i is an integer satisfying 1≦i≦k and ai is a real number}. The receiving device includes: a template generating unit that generates m (m is a positive integer) linear independent template vectors {pᵢ^{→}|1≦i≦m}; a correlation unit that calculates a correlation value {ci=(R^{→}, pᵢ^{→}) 1≦i≦m} between the received signal R^{→} and the template vector {pᵢ^{→}} and outputs a correlation value vector c→ (C₁, C₂, . . . , cₘ); and a multiplying unit that multiplies a transposed matrix of a matrix [ρ_{τ}] by the correlation value vector ca. The matrix [ρ_{τ}] converts a matrix [p] of the m template vectors {pᵢ^{→}} into a matrix [eτ] of signal vectors {e_{iτ}^{→}|1≦i≦m} that are obtained by shifting m signal vectors {eᵢ^{→}|1≦i≦m}, which are obtained by adding (m−k) linear independent signal vectors {eᵢ^{→}|k+1≦i≦m} to the signal vectors {eᵢ^{→}}, by a time τ.

In the receiving device according to the first aspect, first, the correlation between the received signal R^{→} and the template vector {pᵢ^{→}} generated by the receiving device is calculated. Then, the coordinates of the received signal R^{→} in a partial space including the template vector {pᵢ^{→}} are calculated from the correlation value, and the transmitted information is calculated by an inverse matrix of [ρ_{τ}]. When the received signal is considered as a template vector, the correlation value is a scalar. Therefore, it is easy to perform the subsequent process. In addition, since the accuracy of the template vectors or the asynchronization of the received signal is incorporated into the inverse matrix of [ρ_{τ}], it is not important. For this reason, it is possible to perform synchronous detection without accurate synchronization. In addition, the number of template vectors of the transmitter side or the form thereof may be different from that of the receiver side. Therefore, it is possible to select a template vector suitable for reception. In this way, even when a signal having very short duration, such as a UWB-IR signal, is received, the receiver side can easily perform a signal search or signal acquisition using a template vector having long duration signal at the beginning of reception.

### Second Aspect

According to a second aspect of the invention, there is provided a receiving device that receives as a received signal Rⱼ^{→} a series of transmission signals Tⱼ^{→} (Tⱼ^{→}=a₁ⱼe₁^{→}+a₂ⱼe₂^{→}+ . . . +aₖⱼeₖ^{→}) obtained by multiplying k (k is a positive integer) linear independent signal vectors {eᵢ^{→}|i is an integer satisfying 1≦i≦k} by a transmission information coefficient {aᵢⱼ|i is an integer satisfying 1≦i≦k, j is an integer, and aᵢⱼ is a real number}. The receiving device includes: a template generating unit that generates m (m is a positive integer) linear independent template vectors {pᵢ^{→}1≦i≦m}; a correlation unit that calculates a correlation value {cᵢⱼ=(Rⱼ^{→}, pᵢ^{→}) 1≦i≦m} between the received signal Rⱼ^{→} and the template vector {pᵢ^{→}} and outputs a series of correlation value vectors cⱼ^{→} (c₁ⱼ, c₂ⱼ, . . . , Cₘⱼ); and a multiplying unit that multiplies a transposed matrix of a matrix [ρ] by a difference (cⱼ→, cⱼ₋₁^{→}) between the correlation value vector cⱼ^{→} (c₁ⱼ, c₂ⱼ, . . . , cₘⱼ) and the previous correlation value vector cⱼ₋₁^{→}. The matrix [ρ] converts a matrix [p] of the m template vectors {pᵢ^{→}} into a matrix [e] of signal vectors that are obtained by adding (m−k) linear independent signal vectors {eᵢ^{→}|k+1≦i≦m} to the signal vector {eᵢ^{→}}.

The receiving device according to the second aspect can obtain the following effect in addition to the effect of the receiving device according to the first aspect. Since a demodulating operation is continuously performed by a difference between a signal that is being currently received and the previously received signal Rⱼ₋₁ among a series of received signal strings, it is possible to remove a variation in a receiving environment or an error due to the drift of parts of the receiving device.

### Third Aspect

In the receiving device according to the first or second aspect, preferably, the signal vector {eᵢ^{→}} is any one of a Gaussian pulse, an n-order differential pulse of the Gaussian pulse, a Hermite pulse, a modified Hermite pulse, and a pulse obtained by shaping a sine wave using a window function.

In the receiving device according to the third aspect, it is possible to provide a UWB-IR receiving device that is easy to generate UWB-IR pulses and has high characteristics and high performances pulse.

### Fourth Aspect

In the receiving device according to any one of the first to third aspects, preferably, the template vector {pᵢ^{→}} includes a plurality of linear independent sine waves.

According to the receiving device of the fourth aspect, it is possible to use a sine wave that is easy to generate and has long duration as the template vector of the receiving device. Therefore, it is possible to achieve a UWB-IR receiving device having high characteristics and high performances. In addition, even when a pulse set, such as Gaussian mono pulses, which are not orthogonal pulses, is used as the template vectors of the transmitter side, it is possible to use orthogonal pulses as the template vectors of the receiver side. This makes it possible to simplify the demodulating operation of the receiving device.

### Fifth Aspect

In the receiving device according to any one of the first to third aspects, preferably, the template vector {pᵢ^{→}} is formed by shaping a plurality of linear independent sine waves using a variable-length window function.

According to the receiving device of the fifth aspect, it is possible to use a sine wave that is easy to generate and has long duration as the template vector of the receiving device. Therefore, it is possible to achieve a UWB-IR receiving device having high characteristics and high performances. In addition, even when a pulse set, such as Gaussian mono pulses, which are not orthogonal pulses, is used as the template vectors of the transmitter side, it is possible to use orthogonal pulses as the template vectors of the receiver side. This makes it possible to simplify the demodulating operation of the receiving device. In addition, when the template vector is not needed, it is possible to stop the generation of the template vector using the window function. Therefore, it is possible to reduce power consumption of a receiving device.

### Sixth Aspect

In the receiving device according to any one of the first to third aspects, preferably, the template vector {pᵢ^{→}} is formed by reversing the polarity of the signal vector {eᵢ^{→}} and arranging it at equal intervals of time.

According to the receiving device of the sixth aspect, the template vector {pᵢ^{→}} of the receiver side is obtained by reversing the signal vector {eᵢ^{→}}, which is the same as the template vector of the transmitter side, and arranging the reverse template vector arranged at equal intervals of time. Therefore, it is possible to use a sine wave that has strong correlation with the template vector {eᵢ^{→}} and long duration as the template vector of the receiving device. As a result, it is possible to achieve a UWB-IR receiving device having high characteristics and high performances. In addition, even when a pulse set, such as Gaussian mono pulses, which are not orthogonal pulses, is used as the template vectors of the transmitter side, it is possible to use orthogonal pulses as the template vectors of the receiver side. This makes it possible to simplify the demodulating operation of the receiving device.

### Seventh Aspect

In the receiving device according to any one of the first to sixth aspects, preferably, k=1 or 2, and m=2. Preferably, the multiplying unit includes: a first comparing circuit that determines whether the correlation value c1 or c₁ⱼ is positive or negative; a second comparing circuit that determines whether the correlation value c₂ or c₂ⱼ is positive or negative; a third comparing circuit that determines whether the correlation value c₁+c₂ or c₁ⱼ+c₂ⱼ is positive or negative; and a fourth comparing circuit that determines whether the correlation value c₁−c₂ or c₁ⱼ−c₂ⱼ is positive or negative. Preferably, the multiplying unit divides a plane including the template vectors p₁^{→} and p₂^{→} into eight regions, determines which of the regions includes the received signal R^{→} or Rⱼ^{→}, and performs the multiplication on the basis of the determination result.

According to the receiving device of the seventh aspect, the correlation value vector c^{→} is evaluated by a comparing circuit having a simple structure. Therefore, complicated parts are not required for the receiving device. As a result, it is possible to simplify the structure of a receiving device.

### Eighth Aspect

In the receiving device according to any one of the first to sixth aspects, preferably, k=1 or 2, and m=2. Preferably, the multiplying unit includes: a first 2-bit AD conversion circuit that performs AD conversion on the correlation value c₁ or c₁ⱼ; and a second 2-bit AD conversion circuit that performs AD conversion on the correlation value c2 or c2j. Preferably, the multiplying unit divides a plane including the template vectors p₁^{→} and p₂^{→} into twelve regions, determines which of the regions includes the received signal R^{→} or Rⱼ^{→}, and performs the multiplication on the basis of the determination result.

According to the receiving device of the eighth aspect, the correlation value vector c^{→} is evaluated by a 2-bit AD conversion circuit having a simple structure.

Therefore, complicated parts are not required for the receiving device. As a result, it is possible to simplify the structure of a receiving device.

### Ninth Aspect

In the receiving device according to any one of the first to sixth aspects, preferably, k=1 or 2, and m=2. Preferably, the multiplying unit includes: a first 2-bit AD conversion circuit that performs AD conversion on the correlation value c1 or c₁ⱼ; a second 2-bit AD conversion circuit that performs AD conversion on the correlation value c2 or c2j; a third 2-bit AD conversion circuit that performs AD conversion on the correlation value c₁+c₂ or c₁ⱼ+c₂ⱼ; and a fourth 2-bit AD conversion circuit that performs AD conversion on the correlation value c₁−c₂ or c₁ⱼ−c₂ⱼ. Preferably, the multiplying unit divides a plane including the template vectors p₁^{→} and p₂^{→} into twenty four regions, determines which of the regions includes the received signal R^{→} or Rⱼ^{→}, and performs the multiplication on the basis of the determination result.

According to the receiving device of the ninth aspect, the correlation value vector c^{→} is evaluated by a 2-bit AD conversion circuit having a simple structure. Therefore, complicated parts are not required for the receiving device. As a result, it is possible to simplify the structure of a receiving device.

### Tenth Aspect

In the receiving device according to any one of the first to ninth aspects, preferably, the transmission information coefficient a₁ that is transmitted at the beginning of a unit of communication is fixed to predetermined bit information.

According to the receiving device of the tenth aspect, information to be transmitted first is fixed, and the receiver side can determine the constellation of a signal from the coordinates of a received signal vector R^{→}. The correlation value vector of the receiving device depends on the asynchronization of a received signal and the state of transmitted information (the modulated state of a signal).

Even when transmitted bit information is 1 or 0, the same correlation value may be output according to the synchronized state of the signal. Therefore, when it is not known whether the bit information that is transmitted first is 1 or 0, it is difficult for the receiver side to accurately perform demodulation. However, according to the above-mentioned structure, since information that is transmitted first is fixed to predetermined bit information, the receiving device can accurately demodulate received signals.

### Eleventh Aspect

In the receiving device according to any one of the first to ninth aspects, preferably, demodulation is continuously performed, assuming that the transmission information coefficient a₁ that is transmitted at the beginning of a unit of communication is fixed to predetermined bit information, to accurately correct and demodulate the transmission information coefficient {aⱼ} from redundancy included in the transmission information coefficient {aⱼ} that is transmitted for each unit of communication.

According to the structure of the receiving device of the eleventh aspect, a receiving operation is continuously performed while the information that is received first is fixed to predetermined bit information to demodulate exact bit information from redundancy included in transmission information for each unit of communication. The correlation value vector of the receiving device depends on the asynchronization of a received signal and the state of transmitted information (the modulated state of a signal). Even when transmitted bit information is 1 or 0, the same correlation value may be output according to the synchronized state of the signal. Therefore, when it is not known whether the bit information that is transmitted first is 1 or 0, it is difficult for the receiver side to accurately perform demodulation. However, according to the above-mentioned structure, since information that is transmitted first is fixed to predetermined bit information, the receiving device can accurately demodulate received signals.

### Twelfth Aspect

According to a twelfth aspect of the invention, there is provided a receiving method of receiving as a received signal R^{→} a transmission signal T^{→} (T^{→}=a₁e₁^{→}+a₂e₂^{→}+ . . . +aₖeₖ^{→}) obtained by multiplying k (k is a positive integer) linear independent signal vectors {eᵢ^{→}|i is an integer satisfying 1≦i≦k} by a transmission information coefficient {ai|i is an integer satisfying 1≦i≦k and ai is a real number}. The receiving method includes: generating m (m is a positive integer) linear independent template vectors {pᵢ^{→}1≦i≦m}; calculating a correlation value {ci=(R^{→}, pᵢ^{→})|1≦i≦m} between the received signal R^{→} and the template vector {pᵢ^{→}} and outputting a correlation value vector c^{→} (c₁, c₂, . . . , cₘ); and multiplying a transposed matrix of a matrix [ρ_{τ}] by the correlation value vector c^{→}. The matrix [ρ_{τ}] converts a matrix [p] of the m template vectors {pᵢ^{→}} into a matrix [eτ] of signal vectors {e_{iτ}^{→}|1≦i≦m} that are obtained by shifting m signal vectors {eᵢ^{→}|1≦i≦m}, which are obtained by adding (m−k) linear independent signal vectors {eᵢ^{→}|k+1≦i≦m} to the signal vectors {eᵢ^{→}}, by a time T.

### Thirteenth Aspect

According to a thirteenth aspect of the invention, there is provided a receiving method of receiving as a received signal Rⱼ^{→} a series of transmission signals Tⱼ^{→} (Tⱼ^{→}=a₁ⱼe₁^{→}+a₂ⱼe₂^{→}+ . . . +aₖⱼeₖ^{→}) obtained by multiplying k (k is a positive integer) linear independent signal vectors {eᵢ^{→}|i is an integer satisfying 1≦i≦k} by a transmission information coefficient {aᵢⱼ|i is an integer satisfying 1≦i≦k, j is an integer, and aᵢⱼ is a real number}. The receiving method includes: generating m (m is a positive integer) linear independent template vectors {pᵢ^{→}|1≦i≦m}; calculating a correlation value {cᵢⱼ=(Rⱼ^{→}, pᵢ^{→}) 1≦i≦m} between the received signal Rⱼ^{→} and the template vector {pᵢ^{→}} and outputting a series of correlation value vectors cⱼ^{→} (c₁ⱼ, c₂ⱼ, . . . , cₘⱼ); and multiplying a transposed matrix of a matrix [ρ] by a difference (cⱼ^{→}−cⱼ₋₁^{→}) between the correlation value vector cⱼ^{→} (c₁ⱼ, c₂ⱼ, . . . , cₘⱼ) and the previous correlation value vector cⱼ₋₁^{→}. The matrix [p] converts a matrix [p] of the m template vectors {pᵢ^{→}} into a matrix [e] of signal vectors that are obtained by adding (m−k) linear independent signal vectors {eᵢ^{→}|k+1≦i≦m} to the signal vector {eᵢ^{→}}.

According to the above-mentioned structure, it is possible to perform high-performance synchronous detection without accurate synchronization between the received signal and the template pulse generated by the receiving device. In addition, it is possible to reduce the required accuracy of a template pulse generating circuit of a receiving device, a time standard, or a frequency standard. Therefore, it is possible to achieve a receiving device having a simple structure, high precision, high reliability, and low manufacturing costs. In particular, in a UWB-IR communication system using pulses having a wide band and a very narrow width, it is possible to achieve a high-performance receiving device capable of performing synchronous detection for high-speed processing, which has not been performed in the related art. In addition, according to the above-mentioned aspects of the invention, it is possible to improve flexibility in the form of a pulse used in the UWB-IR communication system. Therefore, even in an existing receiving device that uses a special pulse due to its complicated structure, a receiver side can use a template vector that is easy to generate. As a result, it is possible to simplify the structure of a receiving device without lowering the performance of the receiving device.

### BRIEF DESCRIPTION OF THE DRAWINGS

The invention will be described with reference to the accompanying drawings, wherein like numbers reference like elements.

FIG. 1 is a block diagram illustrating the structure and principle of a first embodiment of the invention.

FIGS. 2A and 2B are equations for explaining the structure and principle of the first embodiment of the invention.

FIGS. 3A to 3C are block diagrams illustrating the structures of transmission devices that generate signals to be received in the first embodiment of the invention.

FIG. 4 is a diagram illustrating pulses used in the first embodiment of the invention (part 1).

FIG. 5 is a diagram illustrating pulses used in the first embodiment of the invention (part 2).

FIG. 6 is a diagram illustrating pulses used in the first embodiment of the invention (part 3).

FIGS. 7A and 7B are constellation diagrams illustrating the pulses used in the first embodiment of the invention.

FIG. 8A is a block diagram illustrating the structure of a second embodiment of the invention.

FIGS. 8B and 8C are timing charts illustrating waveforms used in the second embodiment of the invention.

FIG. 9A is a block diagram illustrating the structure of a third embodiment of the invention.

FIG. 9B is a constellation diagram illustrating the third embodiment of the invention.

FIG. 10A is a block diagram illustrating the structure of a fourth embodiment of the invention.

FIG. 10B is a constellation diagram illustrating the fourth embodiment of the invention.

FIGS. 11A to 11F are timing charts illustrating signals received in a fifth embodiment of the invention.

FIGS. 12A and 12B are block diagrams illustrating the structures of transmitting devices that generate signals to be received in the fifth embodiment of the invention.

FIG. 13 is a diagram illustrating pulses used in a sixth embodiment of the invention (part 1).

FIG. 14 is a diagram illustrating pulses used in the sixth embodiment of the invention (part 2).

FIG. 15 is a diagram illustrating pulses used in the sixth embodiment of the invention (part 3).

FIG. 16 is a block diagram illustrating the structure of the sixth embodiment of the invention.

FIG. 17 is a block diagram illustrating the related art.

FIGS. 18A to 18H are timing charts illustrating the related art.

FIG. 19 is a diagram illustrating the related art using signal vectors (part 1).

FIG. 20 is a diagram illustrating the related art using signal vectors (part 2).

FIG. 21 is a diagram illustrating the related art using signal vectors (part 3).

FIG. 22 is a block diagram illustrating the related art using the signal vectors.

FIGS. 23A and 23B are equations for explaining the related art using the signal vectors.

### DESCRIPTION OF EXEMPLARY EMBODIMENTS

Hereinafter, a pulse generating circuit according to an exemplary embodiment of the invention will be described with reference to the accompanying drawings.

### First Embodiment

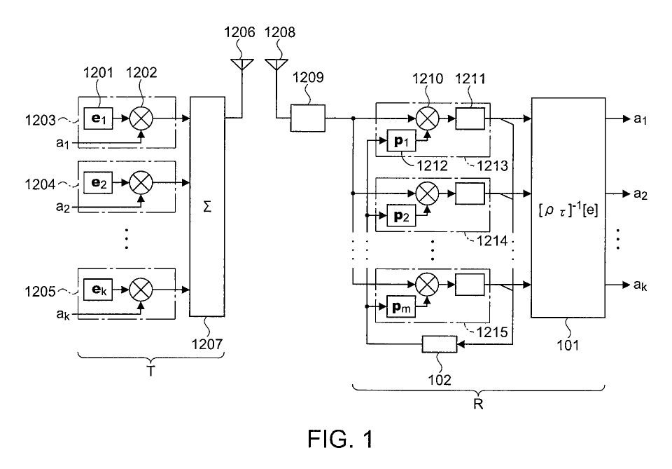

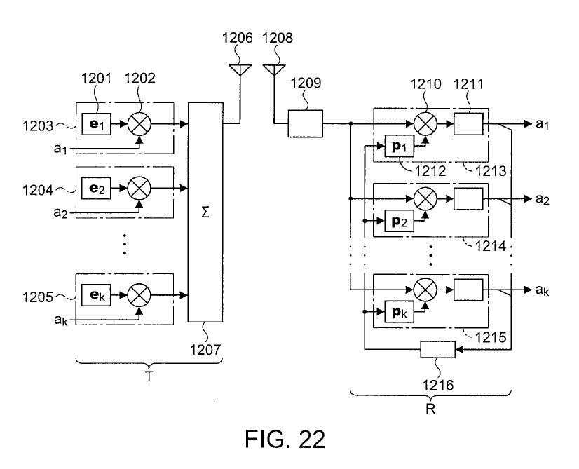

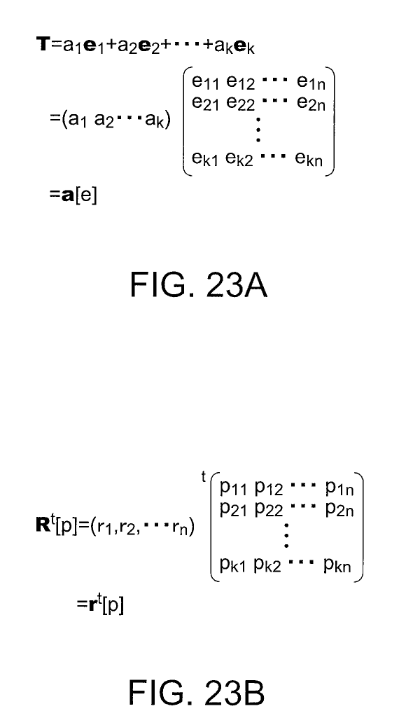

The operating principle of a UWB-IR receiving device according to an embodiment of the invention will be described with reference to FIG. 1. For clarity of description, the same components as those in the related art described with reference to FIGS. 22 and 23 are denoted by the same reference numerals, and a description thereof will be omitted.

The related art has mainly improved a demodulation method of a receiving device. The related art needs to use a template vector {pᵢ→|1≦i≦m} of a receiver side that is the same as a template vector {eᵢ^{→}|1≦i≦k} of a transmitter side to make synchronization therebetween, thereby performing demodulation. In the UWB-IR receiving device according to this embodiment, it is not necessary to use the template vector {pᵢ^{→}|1≦i≦m} of the receiver side that is identical to the template vector {eᵢ^{→}|1≦i≦k} of the transmitter side, and a receiving device can use a vector with a simple structure. In the related art, the number of template vectors (the original number of vectors {pᵢ^{→}}) is k that is equal to the number of template vectors {eᵢ^{→}} of the transmitter side. The number of template vectors may be different from k. In this embodiment, it is assumed that the number of template vectors is m. In this case, m should be equal to or larger than k in order to restore data without acquiring information for each symbol.

Receiving sub-units (correlators) 1213, 1214, 1215 output m correlation results c^{→}, but the correlation results are not demodulated data yet. The demodulated data is obtained by calculating Expression 18, which will be described below, using a processing circuit 101. Reference numeral 102 indicates a control circuit that controls the start of a template vector {pᵢ} or the overall sequence of a circuit.

The correlation value vectors c^{→} of the correlators 1213, 1214, . . . , 1215 are represented by R^{→}t[p] (which is the same as that described in the related art). That is, the correlation value vector c^{→} is represented by Expression 12 given below.

c^{→}=(c₁, c₂, . . . , cₘ)=R^{→t}[p] (12)

When e_{iτ}^{→} (1≦i≦k) is represented by a linear combination of pᵢ^{→}, the following is obtained by Expression 4.

e_{iτ}^{→}=(e_{iτ}^{→}, p₁^{→})p₁^{→}+(e_{iτ}→, p₂^{→})p₂^{→}+ . . . +(e_{iτ}^{→}, pₘ^{→})pₘ^{→} (13)

(where {e_{iτ}^{→}} indicates that there is a time difference between {eᵢ^{→}} and {pᵢ^{→}} without synchronization therebetween). The transmission signal represented by Expression 10 is received as a^{→}[eτ].

e_{iτ}^{→} is represented by Expression 14 given below using the correlation function represented by the Expression 6.

e^{iτ}^{→}=ρₑᵢₚ₁(τ)p₁^{→}+ρₑᵢₚ₂ₚ₂^{→}+ . . . +ρₑᵢₚₘeₘ^{→} (14)

e_{iτ}^{→} (1≦i≦k) is rearranged by Expression 15 given below.

[e_{τ}]=[ρ_{τ}][p] (15)

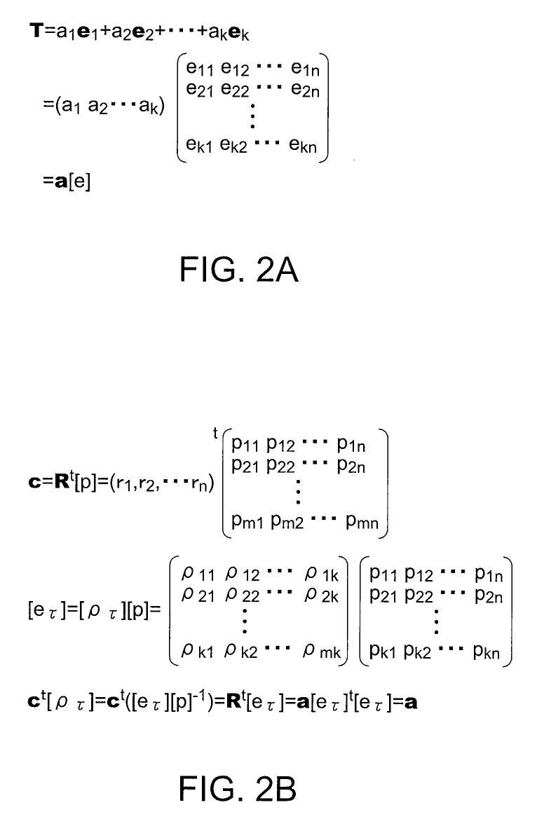

(where [p] indicates a matrix of m rows by n columns that is obtained by arranging pᵢ^{→} (1≦j≦m) in the vertical direction, [p_{τ}] indicates a matrix of k rows by m columns that is obtained by arranging ρₑᵢₚⱼ (1≦i≦k, and 1≦j≦m) in the order of Expression 14, and [e_{τ}] indicates a matrix of k rows by n columns that is obtained by arranging e_{iτ} (1≦i≦k) in the vertical direction (see FIG. 2B, a vector is represented by boldface).

When the processing circuit 101 multiplies the correlation value vectors c^{→} of the correlation circuit 1213 to 1215 by ^{t}[ρ_{τ}] from the right side, transmitted information a^{→} can be demodulated. The reason is as follows. First, Expression 16 given below is obtained by Expression 15.

[p]=[ρ_{τ}]⁻¹[eτ] (16)

When Expression 16 is substituted into Expression 12, Expression 17 given below is obtained.

$$\begin{matrix}\begin{matrix}{c}^{\to } = {R}^{\to t} [ p ] = {R}^{\to } t ( {[ {ρ}_{τ} ]}^{- 1} [ {e}_{τ} ] ) \\ = {{{R}^{\to t} [ {e}_{τ} ]}^{t} [ {ρ}_{τ} ]}^{- 1}\end{matrix} & ( 17 )\end{matrix}$$

It is possible to demodulate the transmitted information a^{→} by calculating R^{→t}[eτ] using Expression 17 as follows.

a^{→}=R^{→t}[e_{τ}]=c^{→t}[ρ_{τ}] (18)

In this way, it is possible to exactly demodulate the transmitted information.

In this case, for convenience, an inverse matrix [ρ_{τ}]⁻¹ is used. The inverse matrix is defined by only a square matrix. Here, [ρ_{τ}] indicates a matrix of k rows by m columns. Only when m=k, the above description can be accepted. When m≠k, the following process is performed. That is, a template vector {eᵢ^{→}|k+1≦i≦m} that is not used is further assumed and is added to [e] to make a matrix [e] of m rows by n columns. Expression 10 is used to calculate a transmission symbol. In this case, all the values of {ai k+1≦i≦m} are set to zero as a^{→}, it is possible to use Expression 10 without any change. {eᵢ^{→}|k+1≦i≦m} is linearly independent from {eᵢ^{→}|1≦i≦k}, and is ideally orthogonal to {eᵢ^{→}|1≦i≦k}. In an n-dimensional space, m template vectors (n>m) are preferably selected. Therefore, this virtual vector {eᵢ^{→}} can be freely selected. In this way, when the m×n matrix [e] is made, it is possible to create [ρ_{τ}]⁻¹ since [ρ_{τ}] is a square matrix. In Expression 18, only the first to k-th columns of [ρ_{τ}] are sufficient to multiply [ρ_{τ}].

In the above description, it is assumed that the same signal as the transmission signal is used as the received signal R^{→}, that is, R^{→}=a^{→}[e]. For [e]^{t}[e], when [e] is a matrix of the vectors eᵢ^{→} that are orthogonal to each other (when [e] is a unitary matrix), the product of [e] and a transposed matrix thereof is a unitary matrix. Therefore, it is easy to perform calculation. When [e] is not a unitary matrix, calculation becomes complicated a little, but it is possible to perform demodulation.

The above assumption R^{→}=a^{→}[e] is not necessarily correct in the actual operation. Only when distortion is completely removed from a transmission path, this expression is established. However, the distortion can be incorporated into [ρ_{τ}] of Expression 15. In this case, the distortion is automatically removed.

In this way, even when the template vector of the receiving device is not exactly synchronized due to the structure of the receiving device, the template vector of the receiving device is not exactly identical to the template vector of the transmitter side, or distortion occurs in the transmission path, it is possible to perform accurate demodulation.

The above description can be analyzed as follows. The template signal {e_{iτ}^{→}} that has been synchronized with the received signal by Expression 15 is created by a linear combination of {pᵢ^{→}}, and demodulation is performed using {pᵢ^{→}} as the created template vector. In this case, a linear combination coefficient can be calculated by a correlation circuit of the receiving device.

Further, the above description can be analyzed as follows. In many cases, T^{→} is represented by a linear combination of {eᵢ^{→}|1≦i≦k}. Since the coefficient of each template vector is a binary value, only 2k points are obtained in a k-dimensional partial space. The receiver side maps them to an m-dimensional partial space of {pᵢ^{→}|1≦i≦m} as 2k points using Expression 15 or Expression 16. When T varies, [ρ_{τ}] also varies. Therefore, the 2k points move in the m-dimensional partial space while leaving a trace. When {pᵢ^{→}} is appropriately selected, the relative positional relationship between these points does not vary even when τ varies, and only one point can exist in each quadrant of the m-dimensional partial space. When transmission information represented by a specific point is known, it is possible to specify transmission information represented by another point. Calculating c^{→}, that is, the correlation between R^{→} and {pᵢ^{→}} using Expression 16 is specifying the position of R^{→} in the quadrants of the m-dimensional partial space, and demodulating a^{→} using Expression 17 is performing demapping from the positions of the points on the m-dimensional partial space to a k-dimensional partial space. When {pᵢ^{→}} and {eᵢ^{→}} (expanded {eᵢ^{→}} including {eᵢ^{→}|k+1≦i≦m} that is not used to create [ρ_{τ}]⁻¹) are in an orthonormal system, multiplying [ρ_{τ}] in Expression 18 is switching the coordinates of a signal vector R^{→} from a coordinate system having {pᵢ^{→}} as an axis to a coordinate system having {eᵢ^{→}} as an axis. The reason is as follows. A matrix for coordinate conversion has the cosine (direction cosine) of an angle formed between the axes, and [ρ_{τ}] is a set of the direction cosines between the vectors {eᵢ^{→}} and {pᵢ^{→}} from this definition. Therefore, [ρ_{τ}] is a matrix for coordinate conversion. Thus, multiplying [ρ_{τ}] is performing coordinate conversion to switch the coordinates.

The next problem is how to know [ρ_{τ}] and to determine which set is selected as the template vector {pᵢ^{→}} in order to reduce the amount of calculation. In many cases, it is possible to perform demodulation when the position of the received signal in the quadrants of a partial space where m template vectors exist is known. Therefore, it is easy to achieve the processing circuit 101.

Next, other exemplary embodiments will be described.

### Second Embodiment

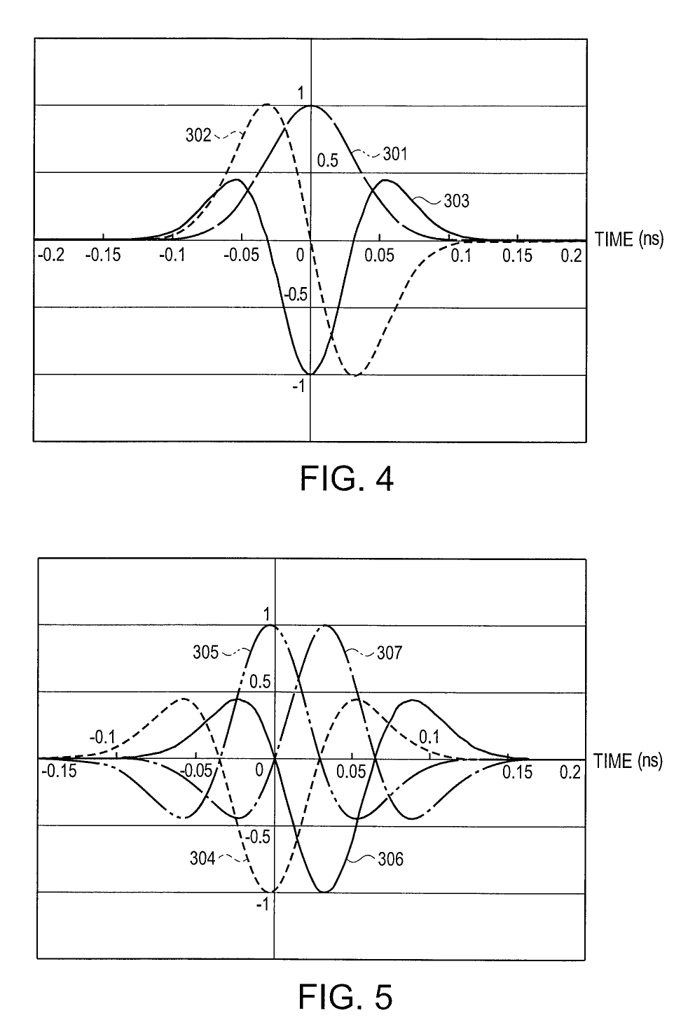

In a second embodiment, Gaussian pulses are used for the template vector of a transmitter side. These pulse waveforms are shown in FIGS. 4, 5, and 6.

In general, as a pulse width is narrowed, the occupied bandwidth of the pulse in a frequency domain is increased. In contrast, a pulse with a narrow bandwidth in the frequency domain is a signal waveform that is continued in a time domain, and is a continuous signal that is not called a pulse. The width of a pulse in the time axis direction is inversely proportional to the frequency bandwidth of a frequency domain, which is called an uncertainty principle. The product thereof can not be reduced to a certain value or less. The Gaussian pulse has been known as a pulse having the smallest product. In general, it has been known that, when an impulse passes through an amplifier, an antenna, or a transmission path, the impulse is approximate to the Gaussian pulse. The Gaussian pulse is a waveform that is denoted by reference numeral 301 in FIG. 4. The Gaussian pulse is represented by Expression 19 given below.

y(t)=exp(−(2πt/t₀)²/2) (19)

(where y(t) indicates the Gaussian pulse, π indicates the ratio of the circumference of a circle to its diameter, t indicates time, and t₀ is a constant for determining a pulse width). In FIGS. 4, 5, and 6, for example, t₀=0.2 ns.

This pulse includes a DC component, and the peak of the spectrum is on the DC component. The spectrum intensity is gradually reduced from the DC and is reduced by half at 0.833 f_{c}. In this case, f_{c}=1/t₀, and in FIGS. 4, 5, and 6, f_{c}=5 GHz. The spectrum band of the pulse is increased from the DC. Therefore, in the IR system, in order to emphasize a wide band, a waveform obtained by differentiating the pulse several times has been generally used. In FIG. 4, reference numerals 302 and 303 denote the first-order differential waveform and the second-order differential waveform of the Gaussian pulse 301, respectively. The characteristics of these waveforms have been studied well, and a peak frequency and a half bandwidth (a bandwidth until the spectrum intensity is reduced by half) of the spectrum are f_{c} and 1.155f_{c} in the first-order differential waveform 302, and 1.414f_{c} and 1.166f_{c} in the second-order differential waveform 303, respectively.

In this embodiment, an example in which the second-order differential waveform 303 is used as the template vector of the transmitter side will be described, but the invention is not limited thereto. For example, any one of the waveforms 301, 302, and 303, a high-order differential waveform, a Hermite pulse, and a modified Hermite pulse may be used as the template vector of the transmitter side.

The transmitter side includes two transmitting sub-units 1203 and 1204 shown in FIGS. 1 and 2 and uses two template vectors e₁^{→} and e₂^{→}. Therefore, the transmitting sub-unit 1205 is omitted.

The second-order differential waveform of the Gaussian pulse that is represented by reference numeral 304 in FIG. 5 is used as the template vector e₁^{→} of the transmitter side. In addition, a waveform 306 obtained by shifting e₁^{→} by a quarter of the time t₀/1.414 is used as the template vector e₂^{→} of the transmitter side. When the values of transmission data (transmission information coefficients) a₁ and a₂ are 1 or 0, a transmission signal T^{→} is a PPM signal having the waveform 304 or 306. In addition, when one of the values of the transmission data a₁ and a₂ is +1 and the other value is 0, a BPM signal having the waveform 304 or an inverted waveform 305 thereof, or the waveform 306 or an inverted waveform 307 thereof is used as the transmission signal. When it is allowed that both the transmission data a₁ and a₂ have a value of ±1, 2 bits can be transmitted for each symbol.

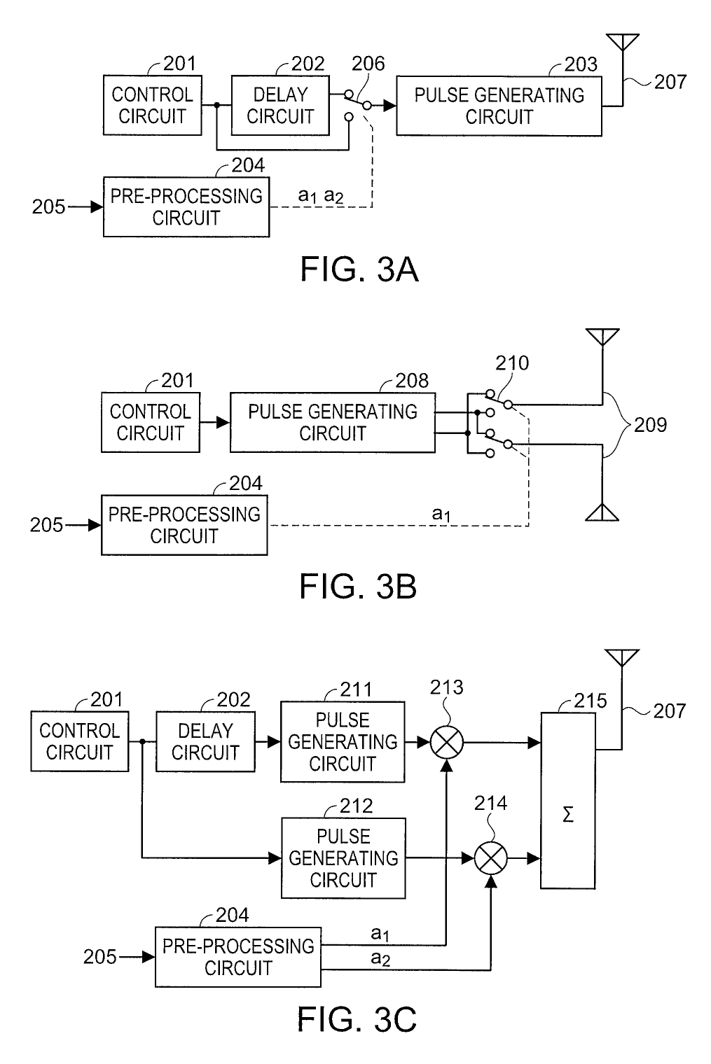

FIG. 1 and FIGS. 2A and 2B are conceptual diagrams illustrating the structure of this embodiment, but the invention is not limited thereto. Other structures capable of embodying the above concept may be used. In this case, the same performance as described above can be obtained. The invention also includes these structures. Next, an example of the circuit structure of a transmitting device will be described with reference to FIGS. 3A to 3C. In FIGS. 3A to 3C, blocks having the same function are denoted by the same reference numeral, and a description thereof will be omitted for clarity of the description of this embodiment.

FIG. 3A is a block diagram illustrating an example of a transmitting device using PPM. The transmitting device includes a control circuit 201 that generates a start signal of a transmission pulse in a predetermined order and at a predetermined timing, a delay circuit 202 that delays the start signal by a predetermined amount of time, a pulse generating circuit 203 that generates the Gaussian pulse, and an antenna 207 that radiates the generated pulse signal as a radio signal.

Transmission data is input to a terminal 205. A pre-processing circuit 204 adds a parity bit to the transmission data, if necessary, performs encoding for error correction, and controls the demodulation of transmission bit information. That is, the pre-processing circuit 204 maps data to a₁ and a₂ such that (a₁ a₂)=(1 0) or (a₁ a₂)=(0 1) is established according to the value 1 or 0 of the transmission bit data. In addition, the pre-processing circuit 204 controls a switch 206 such that the start signal generated by the control circuit 201 is transmitted to the pulse generating circuit 203 directly or through the delay circuit 202 and changes it. When the start pulse is directly transmitted to the pulse generating circuit, the pulse generating circuit 203 generates a pulse. This is the template vector e₁^{→} of the transmitter side that is represented by reference numeral 304 in FIG. 5. When the start signal is transmitted to the pulse generating circuit through the delay circuit 202, a pulse that is delayed by a predetermined amount of time is generated. This is the template vector e₂^{→} of the transmitter side that is represented by reference numeral 306 in FIG. 5. When the predetermined delay amount of the delay circuit 202 is selected such that the correlation between the template vectors is 0, that is, the template vectors are orthogonal to each other (a quarter of t₀/1.414), it is possible to perform PPM with high efficiency.

In addition, the control circuit 201 controls the overall timing or sequence of a transmission device circuit, generates signals for various sequence control operations such that each block can obtain necessary signals or data, if necessary, and performs control such that the transmission device circuit is normally operated.

FIG. 3B is a block diagram illustrating a transmitting device using BPM. A pulse start signal generated by the control circuit 201 is directly transmitted to a pulse generating circuit 208. In this embodiment, the pulse generating circuit 208 having a differential output is used, for example. The pulse generating circuit 208 includes two output terminals, and operates such that a potential difference between the two output terminals generates the pulse that is represented by reference numeral 304 in FIG. 5. The generated pulse is used as the template vector e₁^{→} of the transmitter side. The pre-processing circuit 204 maps +1 or −1 to a₁ according to transmission bit information. A switch 210 inverts the polarity of the pulse according to the value of a₁. If a₁=+1, the waveform 304 (template vector e₁^{→}) shown in FIG. 5 is output without any change. If a₁=−1, the waveform is inverted into the waveform 305 (FIG. 5), and the waveform 305 is output. That is, the switch 210 serves as a multiplying circuit that multiplies e₁^{→} by +1. In this way, the BPM is performed. The pulse signal, which is the differential output, that is switched by the switch 210 is radiated as a radio signal by a balanced antenna 209. Of course, for example, a balun may be used to perform differential-to-single-end conversion (balanced to unbalanced conversion) to the pulse signal to drive an unbalanced antenna.

FIG. 3C is a block diagram illustrating the structure of a transmitting device for generating the waveforms 304 and 306 shown in FIG. 5 using pulse generating circuits 211 and 212. The start signal generated by the control circuit 201 is directly input to the pulse generating circuit 212 without passing through the delay circuit 202, and the pulse generating circuit 212 generates the waveform 304 shown in FIG. 5. The signal vector of the waveform is e₁^{→}. The start signal generated by the control circuit 201 is input to the pulse generating circuit 211 through the delay circuit 202. Therefore, the pulse generating circuit 211 generates a waveform having a time delay with respect to the signal vector e₁^{→}, that is, the waveform 306 shown in FIG. 5. The signal vector of the waveform 306 is e₂^{→}. As described above, when the predetermined delay amount of the delay circuit 202 is set to a quarter of t₀/1.414, the correlation between the vectors e₁^{→} and e₂^{→} is 0, that is, the vectors are orthogonal to each other. Therefore, it is possible to perform communication with high efficiency.

The pre-processing circuit 204 adds redundancy for error correction or parity to transmission information, and maps 2-bit transmission data to each of the transmission data a₁ and a₂. That is, the pre-processing circuit 204 maps a^{→}=(a₁ a₂)=(1 1), (−1 1), (1 −1), (−1 −1) to four 2-bit information items (0 0), (1 0), (0 1), and (1 1). This information is input to multiplying circuits 213 and 214 and then multiplied by the pulse signal generated by the pulse generating circuit 211 or 212. An adding circuit 215 adds the outputs of the multiplying circuits to generate a transmission signal T^{→} that is represented by Expression 20 given below.

T=a₁e₁^{→}+a₂e₂^{→}=a[e] (20)

The added signal is radiated by the antenna 207. In the above expression, [e] indicates a 2×n matrix of the row vectors e₁^{→} and e₂^{→} arranged in the vertical direction. This circuit can transmit 2-bit information for each symbol.

Next, an example of the circuit structure of the receiving device will be described. The signal T^{→}=a^{→}[e] transmitted from the transmitting device is delayed while passing through a transmission path, and then received by the receiving device. This signal is referred to as a received signal R^{→}. In the related art, synchronization acquisition or synchronization tracking is performed to match the timings of the template vectors of the receiver and transmitter sides such that demodulation can be performed well at all times, thereby calculating correlation. In this embodiment, correlation is calculated without correcting the deviation between the timings. In FIGS. 1, 2A and 2B, the correlation circuits of the correlators 1213 and 1214 calculate the inner products of R^{→}, and p₁^{→} and p₂^{→}, respectively. When the inner products are referred to as c1 and c2, c1 is represented by Expression 21 given below:

$$\begin{matrix}\begin{matrix}{c}_{1} = ( {R}^{\to } , {p}_{1}^{\to } ) \\ = ( {T}_{τ}^{\to } , {p}_{1}^{\to } ) \\ = ( {a}^{\to } [ {e}_{τ} ] , {p}_{1}^{\to } ) \\ = ( {a}_{1} {e}_{1 τ}^{\to } + {a}_{2} {e}_{2 τ}^{\to } , {p}_{1}^{\to } ) \\ = {a}_{1} {ρ}_{e 1 p 1} ( τ ) + {a}_{2} {ρ}_{e 2 p 1} ( τ )\end{matrix} & ( 21 )\end{matrix}$$

(where ρₑ₁ₚ₁(τ) and ρₑ₂ₚ₁(τ) indicate cross correlation functions between e₁ and e₂, and P₁, respectively, a suffix of T indicates a signal that is delayed from the original signal by a time of T, and T indicates a relative time relation between {pᵢ^{→}} and {eᵢ^{→}}).

Time difference indicating asynchronization may be considered.

Similarly, c2 is represented by Expression 22 given below.

$$\begin{matrix}\begin{matrix}{c}_{2} = ( {R}^{\to } , {p}_{2}^{\to } ) \\ = ( {T}_{τ}^{\to } , {p}_{2}^{\to } ) \\ = ( {a}^{\to } [ {e}_{τ} ] , {p}_{2}^{\to } ) \\ = {a}_{1} {ρ}_{e 1 p 2} ( τ ) + {a}_{2} {ρ}_{e 2 p 2} ( τ )\end{matrix} & ( 22 )\end{matrix}$$

Expressions 21 and 22 are rearranged as follows.

c^{→}=(c₁, c₂)=R^{→t}[p]=a^{→}[ρ_{τ}]⁻¹ (23)

(where [ρ_{τ}]⁻¹ indicates a matrix of the correlation values of Expressions 21 and 22 (it is noted that [ρ_{τ}]⁻¹ differs from [ρ_{τ}] that is obtained when k=m=2 in Expression 14 in that components of the matrix are arranged in a different order)).

The transposition relationship is established between the two matrices. As in this embodiment, when an orthonormal system is used as {eᵢ^{→}} and {pᵢ^{→}}, [ρ_{τ}]⁻¹ is an inverse matrix of [ρ_{τ}] (which is called a unitary matrix or an orthogonal matrix). In order to ensure consistency, the transposed matrix is represented by [ρ_{τ}]⁻¹ in Expression 23. When the coefficient matrix of Expression 23 is represented by [ρ_{τ}]⁻¹, [ρ_{τ}], which is an inverse matrix of [ρ_{τ}]⁻¹, is a coefficient matrix when {eτi→} is represented by a linear combination of {pᵢ^{→}}. That is, Expression 15 can be used without any change. When [ρ_{τ}], which is an inverse matrix of [ρ_{τ}]⁻¹, is calculated by Expression 23, the transmitted information a^{→} can be calculated (demodulated) by Expression 24 given below.

a^{→}=c→[ρ_{τ}] (24)

However, in general, τ varies due to, for example, a variation in delay in the transmission path, the Doppler shift, timing mismatch in the circuit, and a template vector error, and it is difficult to specify the value of τ in advance. Therefore, it is difficult to know [ρ_{τ}] in advance. In order to know [ρ_{τ}], it is necessary to estimate c from the output of the correlator having received a signal. The correlation value is changed due to the demodulated state of the signal (the value of a^{→}) as well as τ. When τ is changed in the signal that is demodulated by bit information 1 and the signal that is demodulated by bit information 0, it is possible to obtain the same correlation value. Therefore, when it is not known which information is being currently received, it is difficult to determine τ. In order to solve this problem, a method has been proposed which transmits known information to specify τ and transmits desired information. That is, for example, when it is set that a^{→}=(1, −1) is transmitted at the beginning, the receiver side can specify τ from c^{→} when receiving the information, thereby knowing [ρ_{τ}]. As a result, the receiver side can calculate [ρ_{τ}]⁻¹.

Examples of a method of simply calculating [ρ_{τ}]⁻¹ and a method of finding τ will be described below.

An example in which the transmitter side uses the Gaussian pulse as the template vector has been described above. In this embodiment, the following two vectors are used as the template vectors of the receiver side that has received the signal transmitted by the transmitting device, that is, the template vectors described with reference to FIGS. 1, 2A, and 2B.

p₁^{→}=cos(2πfₚt) (25)

p₂^{→}=sin(2πfₚt) (26)

Therefore, in FIG. 1, the correlator 1215 is omitted. In the above expressions, fp indicates a peak frequency of the spectrum of the pulse used for the template vector of the transmitter side. However, in the Gaussian pulse, since the peak frequency is a DC (0 Hz), f_{c} (=1/t₀) is used.

Each of the template vectors e₁^{→} and e₂^{→} of the transmitter side can be approximately calculated by a linear combination of p₁→ and p₂^{→} according to Expression 5. That is, the template vectors e₁^{→} and e₂^{→} are respectively calculated by Expressions 27 and 28 given below.

e₁^{→}≈(e₁^{→}, pᵢ^{→})pᵢ^{→}+(e₁, p₂^{→})p₂^{→} (27)

e₂^{→}≈(e₂^{→}, p₁^{→})p₁^{→}+(e₂, p₂^{→})p₂^{→} (28)

They are rearranged as follows.

[e][ep][p] (29)

(where [e] indicates a matrix of the row vectors e₁^{→} and e₂^{→} arranged in this order in the vertical direction, and [ep] is a matrix of (e₁^{→}, pⱼ^{→}) (i and j are 1 or 2) arranged in the order represented by Expressions 27 and 28, and [p] indicates a matrix of the row vectors p₁^{→} and p₂^{→} arranged in this order in the vertical direction).

In this case, a coefficient for normalization is omitted for simplicity. The omission of the coefficient does not affect the essence of the invention.

In this embodiment, as described above, the two waveforms 304 and 306 shown in FIG. 5 are used as e₁^{→} and e₂, respectively. When trigonometrical functions of Expressions 27 and 28 are respectively used as p₁^{→} and p₂^{→}, [ep] is a unitary matrix. The reason is as follows. Since e₁^{→} is an even function and p₂^{→} is an odd function, (e₁^{→}, p₂^{→}) is zero. In addition, since e₂^{→} and p₁^{→} are waveforms obtained by delaying e₁^{→} and p₂^{→} by a time of 1/(4fp), respectively, (e₂^{→}, p₁^{→}) is zero. Since (e₁^{→}, p₁^{→}) and (e₂^{→}, p₂^{→}) have the same waveform, but there is a time delay therebetween, they have finite values, not zero. In this embodiment, since the coefficient for normalization is neglected, [ep] is a unitary matrix. That is, e₁^{→}≈p₁^{→}, and e₂^{→} p₂^{→}. This is rearranged as follows.

[e]≈[p] (30)

This is an approximation method capable of minimizing an energy error when the template vectors e₁^{→} and e₂^{→} are approximately calculated by a linear combination of p₁^{→} and p₂^{→}. Therefore, the receiver side can select a good template vector using the above approximation method, without using the same template vector in both the transmitter side and the receiver side. In addition, the receiving device can use, as the template vector, a continuous wave, not a single-shot pulse used as the template vector of the transmitter side. There are various restrictions, such as a spectrum mask (there is no radio component resistant to a specific frequency), in the template vector of the transmitter side, since the template vector is propagated in a space as a radio wave. However, the receiver side does not need to use the same template vector as that of the transmitter side, and the receiving device uses a template vector that can be easily generated. Therefore, it is possible to reduce the load of a pulse generating circuit and thus simplify the structure of the receiving device.

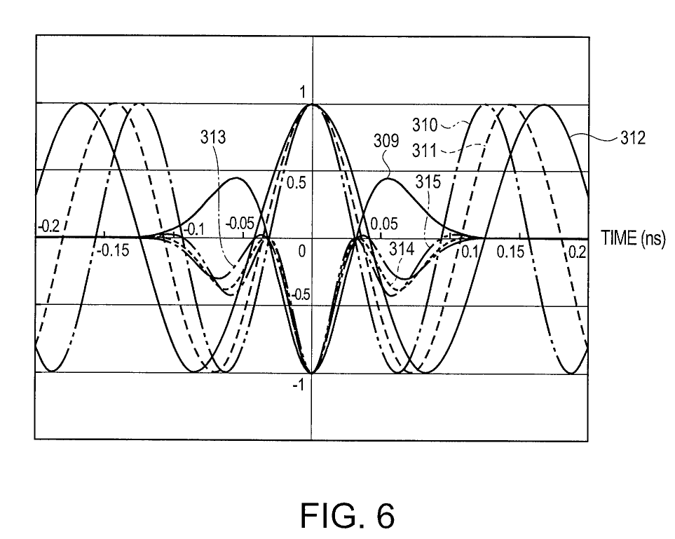

When the trigonometrical function is used, the errors of e₁^{→} and e₂^{→} are constant even when they are shifted (delayed) by a predetermined amount of time in the temporal direction. In addition, the accuracy of a frequency for approximation is less important than that. FIG. 6 shows this aspect. In a Gaussian second-order differential pulse, when fp is 1.414f_{c}, that is, fp is approximately 7 GHz (f_{c}=5 GHz). FIG. 6 shows a process of calculating a coefficient in order to approximately calculate e₁^{→} using Expressions 27 and 28. For example, FIG. 6 shows the result of multiplication between a Gaussian second-order differential pulse e₁^{→} (309) and p₁^{→} in order to calculate the coefficient of p₁^{→}, that is, (e₁^{→}, p₁^{→}) in Expression 27. Three kinds of trigonometrical functions (cosine waves) of fp=6 GHz, 7 GHz, and 8 GHz are used as p₁^{→}, and the multiplied results are compared.

Waveforms 310, 311, and 312 indicate cosine waves having fp of 8, 7, and 6 GHz, respectively, and waveforms 313, 314, and 315 are obtained by multiplying the waveforms 310, 311, and 312 by the Gaussian second-order differential pulse e₁^{→} (309), respectively. In order to calculate a coefficient (e₁^{→}, p₁^{→}, it is preferable to calculate the integral values of the waveforms. There is little difference between the waveforms 313, 314, and 315. That is, as described above, even when the frequency is changed by about 10%, approximation by Expressions 27 and 28 is little affected by the variation. This considerably reduces the required accuracy of components of the receiving device, which makes it easy to configure the device.

Next, a process of calculating [ρ_{τ]} of Expression 15 or Expression 24 using the properties of p₁^{→} and p₂^{→} will be described.

Signals e_{1τ}^{→}, and e_{2τ}^{→}, that are respectively delayed from e₁^{→} and e₂^{→} by a time of T are approximately calculated by Expression 30 as follows.

$$\begin{matrix}\begin{matrix}{e}_{1 τ}^{\to } \approx cos ( 2 π {f}_{p} ( t - τ ) ) \\ = cos ( 2 π {f}_{p} τ ) {p}_{1}^{\to } + sin ( 2 π {f}_{p} τ ) {p}_{2}^{\to }\end{matrix} & ( 31 ) \\ \begin{matrix}{e}_{2 τ}^{\to } \approx sin ( 2 π {f}_{p} ( t - τ ) ) \\ = - sin ( 2 π {f}_{p} τ ) {p}_{1}^{\to } + cos ( 2 π {f}_{p} τ ) {p}_{2}^{\to }\end{matrix} & ( 32 )\end{matrix}$$

These are rearranged as follows.

[eτ][dp][p] (33)

(where [dp] indicates a matrix of the coefficients of Expressions 31 and 32, that is, [ρ_{τ}], and is also a coefficient matrix when [eτ] is approximated to [p] by Expression 33).

When the transmission signal described in Expression 20 is demodulated by the receiver side, it is not necessary to match the timings of [e] and [p] in order to calculate correlation. Therefore, it is not necessary to compensate for timing mismatch between {eᵢ^{→}} and {pᵢ^{→}} using synchronization and perform demodulation using Expression 11, unlike the related art. Unlike the related art, a^{→}[eτ], not T^{→} (=a^{→}[e]), can be substituted into R^{→} in Expression 11. That is, the following relationship is established.

R^{→}=a^{→}[e_{τ}]≈a^{→}[dp][p] (34)

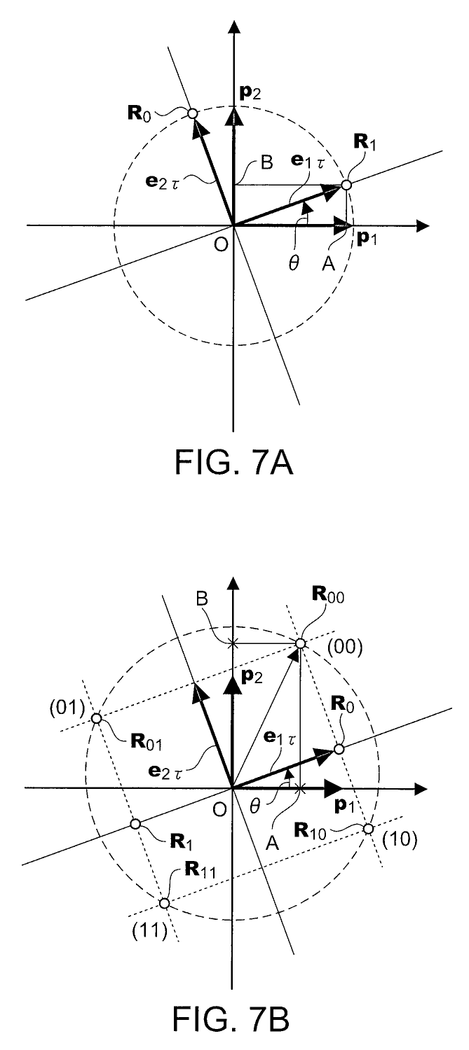

A rear portion of Expression 34 is obtained by substituting [dp][p] into [eτ] using Expression 33. That is, the received signal R^{→} is represented by a linear combination of p₁^{→} and p₂^{→}. [dp] is a matrix indicating the influence of a frequency shift due to a delay in the transmission path or the Doppler effect, which causes the received signal R^{→} to move on the plane (the vicinity of the plane) including the vectors p₁^{→} and p₂^{→}. The movement can be represented by constellation diagrams shown in FIGS. 7A and 7B. FIGS. 7A and 7B are cross-sectional views taken along the plane (a 2-dimensional partial space including p₁^{→} and p₂^{→}) including the vectors p₁^{→} and p₂^{→} in an n-dimensional space including all the signal vectors. The received signal vector R^{→} is disposed on the plane or in the vicinity of the pole thereof. Approximation by Expression 33 or Expression 34 is plotting the orthogonal projection of R^{→} on the plane.

FIG. 7A is a constellation diagram illustrating the transmission signal of the transmitting device using PPM shown in FIG. 3A. For the template vectors p₁^{→} and p₂^{→} of the receiver side, the template vectors e₁^{→} and e₂^{→} of the transmitter side are received as e_{1τ}^{→} and e_{2τ}^{→}. In the case of PPM, a^{→}=(1 0) or (0 1) is set to correspond to transmission information 1 or 0. Therefore, e_{1τ}^{→} or e_{2τ}^{→} that is inclined at a certain angle (0=2πfρ_{τ}) with respect to the template vectors p₁^{→} and p₂^{→} is a received signal vector (in FIG. 7A, R₁^{→} or R₀^{→}). In addition, in FIG. 7A, the vector is represented by boldface according to custom, and the symbol ‘^{→}’ indicating a vector in this specification is omitted.

In FIG. 7A, intersection points between p₁^{→} and p₂^{→} and the perpendicular lines from R₁ are referred to as A and B. When R₁^{→} is received, the outputs of the correlation circuit for p₁^{→} and p₂^{→} indicate the lengths of segments OA and OB, respectively. In this way, it is possible to directly calculate θ from Expression 21 or Expression 31. When θ is calculated, τ is found, and the correlation between e_{2τ}^{→}, and p₁^{→} and p₂^{→} can be calculated by Expression 32. In this way, [dp] can be determined in Expression 33, and it is possible to demodulate the transmitted information a^{→} using Expression 24. In the above description, when R₁^{→} is received, [dp] is determined by the correlation with p₁^{→} and p₂^{→}. However, when R₀^{→} is received, [dp] may be determined by the correlation with p₁^{→} and p₂^{→} using the same calculation as described above. On the contrary, when it is not known whether the received signal is R₀^{→} or R₁^{→}, it is difficult to determine θ using the above-mentioned method. A method of determining θ when it is not known whether the received signal is R₀^{→} or R₁^{→} will be described below.

FIG. 7B is a constellation diagram illustrating the transmission signal of the transmitting device that uses BPM for two template vectors, which is shown in FIG. 3C. Since a^{→}=(a₁ a₂)=(1 1), (−1 1), (1 −1), (−1 −1) is mapped by the pre-processing circuit 204, any one of four points R₀₀^{→}, R₀₁^{→}, R₁₀^{→}, and R₁₁^{→} represents the received signals by the content of the transmitted information. In addition, since the BPM system using one template vector shown in FIG. 3B does not use e₂^{→}, the signal oriented only in the direction of e_{1τ}^{→} is received, and the point R₀ or R₁ indicates the received signal corresponding to the transmitted information in FIG. 7B. In this case, since e₂^{→} is not used, the above principle can be applied without any change, if a₂≡0.

Intersection points between p₁^{→} and p₂^{→} and the perpendicular lines from R₁ to p₁^{→} and p₂^{→} are referred to as A and B. When R₀₀^{→} is received, the outputs of the correlation circuit for p₁^{→} and p₂^{→} indicate the lengths of segments OA and OB, respectively. In this case, θ can be calculated as follows.

θ=tan⁻¹(OB/OA)−π/4 (35)

(where −π/4 indicates a correction term for simultaneously transmitting e₁^{→} and e_{2τ}^{→}).

When θ is calculated, τ is found, and the correlation between e_{1τ}^{→}, and p₁^{→} and p₂^{→} can be calculated by Expression 31. In addition, the correlation between e_{2τ}^{→}, and p₁→ and p₂^{→} can be calculated by Expression 32. In this way, [dp] can be determined in Expression 33, and it is possible to demodulate the transmitted information a^{→} using Expression 24. In the above description, when R₀₀^{→} is received, [dp] is determined by the correlation with p₁⁻ and p₂^{→}. When any of the symbols R₀₁^{→}, R₁₀^{→}, and R₁₁→ is received, [dp] may be determined by the correlation with P1- and p₂^{→} using the same calculation as described above.

On the contrary, when it is not known whether the received signal is R₀₀^{→}, R₀₁^{→}, R₁₀^{→}, or R₁₁→, it is difficult to determine θ using the above-mentioned method. A method of determining θ when it is not known whether the received signal is R₀₀^{→}, R₀₁^{→}, R₁₀^{→}, or R₁₁^{→} will be described below.

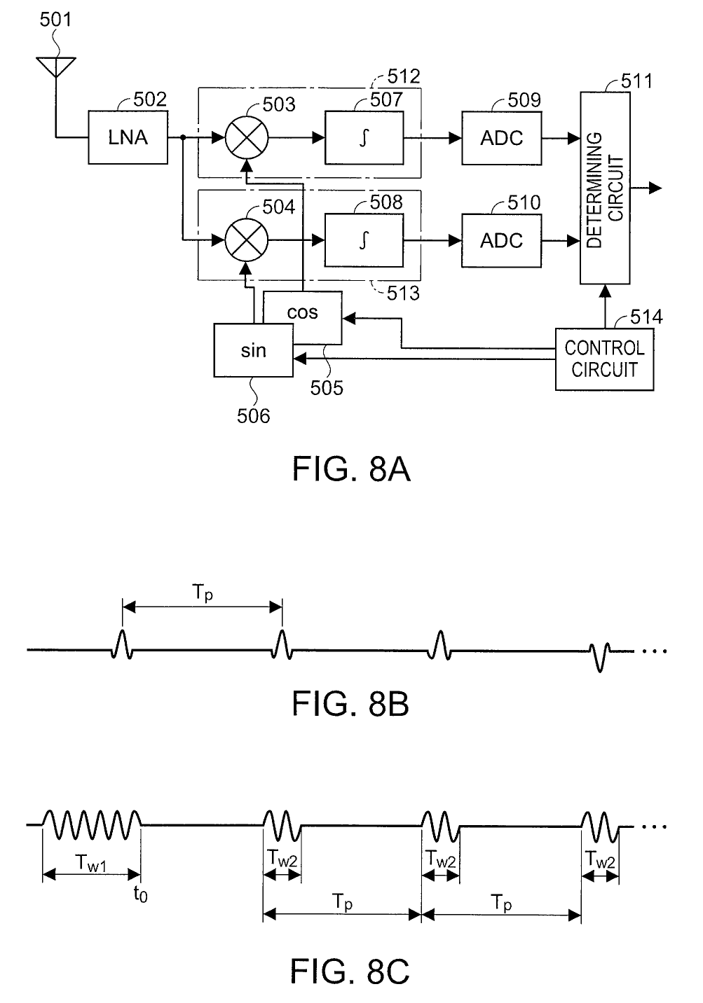

FIG. 8A is a block diagram illustrating an example of the structure of the receiving device according to this embodiment. A UWB signal R^{→} received by an antenna 501 is amplified by a low noise amplifying circuit (LNA) 502, and the correlation between the amplified signal and the template vector p₁^{→} of the receiver side is calculated by a correlation circuit 512 including a multiplying circuit 503 and an integrating circuit (∫) 507. In addition, the amplified signal is input to a correlation circuit 513 including a multiplying circuit 504 and an integrating circuit 508, and the correlation between the amplified signal and the template vector p₂^{→} of the receiver side is calculated by the correlation circuit 513. Template generating circuits 505 and 506 are cosine wave and sine wave generating circuits, and generate the template vectors p₁^{→} and p₂^{→} that are determined by Expressions 25 and 26, respectively. The outputs of the correlation circuit 512 and the correlation circuit 513 are scalars, and are converted into digital values by AD conversion circuits (ADC) 509 and 510, respectively. Then, the digital values are transmitted to a determining circuit 511. The determining circuit 511 calculates a^{→} from the digital values using the above-mentioned method, and demodulates it. A control circuit 514 controls the timings and sequences of the determining circuit 511, the template generating circuits 505 and 506, and the other circuits. In particular, the template generating circuits 505 and 506 are not needed when there is no received pulse signal. Therefore, the control circuit controls the template generating circuits to generate template vectors only when a pulse is received.

In this way, it is possible to reduce the power consumption of a system. The control circuit 514 monitors the outputs of the correlation circuits 512 and 513, and increases the width of the template vector until a signal is acquired. When the output of the correlation circuit increases, the control circuit 514 detects the increase in the output. Thereafter, the control circuit 514 operates the template generating circuits 505 and 506 at the timing when it is expected that the next pulse signal will be received, according to a time standard set therein.

This process will be simply described with reference to a timing chart. FIG. 8B shows the received signal R^{→}, and FIG. 8C shows a template waveform, that is, p₁^{→} or p₂^{→}. That is, until a received signal is found first (before the time to in FIG. 8C), the widths (pulse width TW1) of p₁^{→} and p₂^{→} increase to easily find the initial signal. After the initial signal is received, the control circuit controls the template generating circuits to generate template waveforms having a narrow pulse width at a time interval of Tp according to the time standard set therein. It is ideal that the time standard for determining the transmission timing of the transmitter side is completely identical to that of the receiver side, but there is a difference therebetween. When the width Tw2 of the template pulse is increased so as to overlap the received signal pulse even though there is a difference between the time standards, it is possible to remove an error caused by the difference between the time standards of the transmitter and receiver sides.

The value of θ of the previously received pulse calculated by Expression 35 is stored, and the transfer information of a pulse is estimated from the stored value using a difference between the stored value of θ and the value of θ of the pulse that is being currently received. In this case, it is possible to perform demodulation with little error. That is, for example, in the case in which two transmission template vectors shown in FIG. 3C are used to transmit 2 bits for each symbol, when θ of the previously received pulse R₀₀ is θᵢ−1 and θ of the pulse being currently received is θi, it is determined whether the received signal is R₀₀^{→}, R₀₁^{→}, R₁₀^{→}, or R₁₁^{→} on the basis of θi−θi−1 is θ, π/4, −π/4, or π. Even when R^{→} is moved on the constellation diagram by θᵢ−θᵢ₋₁, it is possible to determine bits on the basis of the difference therebetween at all times. Therefore, this demodulation method does not accumulate errors. As a result, it is possible to perform accurate demodulation even when an error occurs in the template vector due to a time delay in the transmission path, the Doppler shift, and the difference between the time standards of the transmitter and receiver sides. When θ is calculated, T is found, and [dp], that is, ρ_{τ} is found by Expressions 31 to 33. Therefore, ρ_{τj-1} is stored, and bits for each symbol are determined on the basis of a difference between ρ_{τj-1} and ρ_{τ}.

In the above description, the signal (any one of R₀₀^{→}, R₀₁→, R₁₀^{→}, and R₁₁→) to be initially transmitted is determined in advance. As such, when information to be initially transmitted is determined in advance, it is possible to determine another point R^{→} at the time when the signal is initially received, and perform demodulation. However, even when the information to be initially transmitted is not determined in advance, the receiver side can accurately demodulate the information. In this case, demodulation is performed assuming that the signal point R₀₀^{→} is initially received. Then, one unit of communication information is further received, and the redundancy of an error symbol or the parity added to the received information is used to demodulate accurate information. For example, when a parity is added to each transmission template vector in the unit of communication and bits of the information are determined such that one of the bits of the information 1 and 0 is an odd number and the other bit is an even number, it is possible to receive all units of communication and accurately demodulate them.

The term ‘unit of communication’ means the length of one word of transmission information, or the length of a coding block. An error correction code may be used to perform the same process as described above. As described above, the addition of redundancy is inevitable in a wireless communication system. As a result, a processing load increases, and manufacturing costs increase.

As described above, according to this embodiment of the invention, the receiving device can perform accurate synchronous detection, without requiring synchronization acquisition and synchronization tracking, unlike the related art. In addition, since the receiver side does not necessarily need to use the same template vector as that of the transmitter side, the receiving device can select a good template vector. Therefore, in a UWB-IR communication system that receives signals having short duration, particularly, in the communication system according to this embodiment that uses a one-shot pulse, such as the Gaussian pulse, it is possible to use a template pulse having a large pulse width at the beginning of the search of signals, and thus it is easy to acquire the signals. In addition, after the acquisition, it is possible to increase the duration of the template vector, if necessary. Therefore, it is possible to reduce the power consumption of the receiving device. Further, since this structure does not require high-precision parts or operations, it is possible to achieve a synchronous detection receiving device having high accuracy and low power consumption.

### Third Embodiment

In the second embodiment, in order to determine [dp], the output of the correlator is subjected to AD conversion and computed by digital processing. This structure is easy to obtain high accuracy and is simplified. With the development of a semiconductor technique, a manufacturing process has been simplified. However, a receiving device having a simpler structure without using an AD converter is expected. Hereinafter, a receiving device having a simpler structure, particularly, a receiving device suitable for BPM according to a third embodiment will be described.

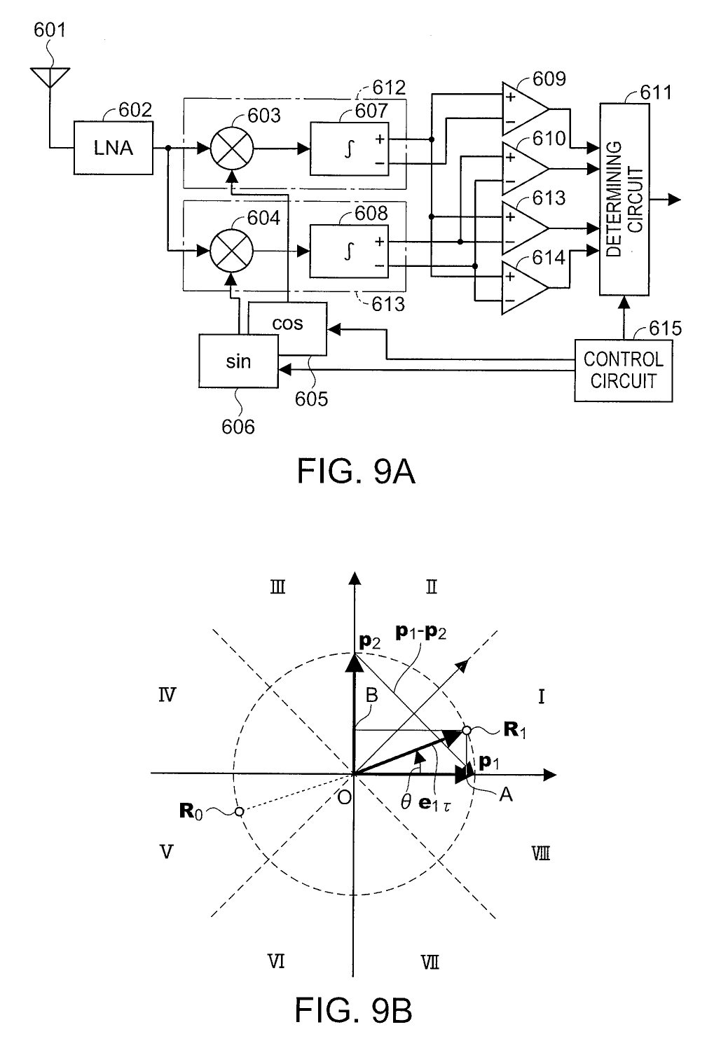

FIG. 9A is a block diagram illustrating an example of the structure of a receiving device according to this embodiment. A UWB signal R^{→} received by an antenna 601 is amplified by a low noise amplifying circuit (LNA) 602, and the correlation between the amplified signal and a template vector p₁^{→} of the receiver side is calculated by a correlation circuit 612 including a multiplying circuit 603 and an integrating circuit (∫) 607. In addition, the amplified signal is input to a correlation circuit 613 including a multiplying circuit 604 and an integrating circuit 608, and the correlation between the amplified signal and a template vector p₂^{→} of the receiver side is calculated by the correlation circuit 613. Template generating circuits 605 and 606 are cosine wave and sine wave generating circuits, and generate the template vectors p₁^{→} and p₂^{→} that are determined by Expressions 25 and 26, respectively. The correlation circuits 612 and 613 have differential outputs. When the receiving device is composed of a semiconductor integrated circuit, it is preferable to use a differential circuit in order to reduce distortion or noise. In this embodiment, since the correlation circuits 612 and 613 require differential outputs, differential circuits may be used for the antenna 601, the low noise amplifying circuit (LNA) 602, the multiplying circuits 603 and 604, and the template generating circuits 605 and 606, if necessary.

A control circuit 615 controls the timings and sequences of a determining circuit 611, the template generating circuits 605 and 606, and the other circuits. As described in the above embodiment, the control circuit controls the template generating circuits 605 and 606 to determine the duration of pulses. When accurately predicting the time when the next signal is received, the control unit decreases the pulse duration. When uncertain components remain, the control unit increases the pulse duration to reduce the overall power consumption of the receiving device.

The outputs of the correlation circuit 612 and the correlation circuit 613 are input to comparing circuits 609, 610, 613, and 614, and the comparing circuits determine whether the received signals are positive or negative. That is, the comparing circuit 609 determines whether the correlation between p₁^{→} and R^{→} is negative or positive, and the comparing circuit 610 determines whether the correlation between p₂^{→} and R^{→} is negative or positive. In addition, the comparing circuit 613 determines whether a difference between the correlation between p₁^{→} and R^{→} and the correlation between p₂^{→} and R^{→} is positive or negative (determines which correlation is large), and the comparing circuit 614 determines whether the sum of the correlation between p₁^{→} and R^{→} and the correlation between p₂^{→} and R^{→} is positive or negative. The difference between the correlation between p₁^{→} and R^{→} and the correlation between p₂^{→} and R^{→} means the correlation between (p₁^{→}-p₂^{→}) and R^{→}, and the sum of the correlation between p₁^{→} and R^{→} and the correlation between p₂^{→} and R^{→} means (p₁^{→}+p₂^{→}) and R^{→}. As shown in the constellation diagram of FIG. 9B, it is possible to know which of eight regions I to VIII the received signal R^{→} exists in, from the determination results of these four comparing circuits.

That is, when the determination result of the comparing circuit 609 is positive, the received signal R^{→} is in any one of the regions I, II, VII, and VIII. When the determination result is negative, the received signal R^{→} is in any one of the regions III to VI. In addition, when the determination result of the comparing circuit 610 is positive, the received signal R^{→} is in any one of the regions I to IV. When the determination result is negative, the received signal R^{→} is in any one of the regions V to VIII. Further, when the determination result of the comparing circuit 613 is positive, the correlation between R^{→} and (p₁^{→}-p₂^{→}) is positive. Therefore, the received signal R^{→} is in any one of the regions VI to VIII and I. When the determination result is negative, the correlation between R^{→} and (p₁^{→}-p₂^{→}) is negative, and the received signal R^{→} is in any one of the regions II to V. Similarly, when the determination result of the comparing circuit 614 is positive, the correlation between R^{→} and (p₁^{→}+p₂^{→}) is positive. Therefore, the received signal R^{→} is in any one of the regions I, II, III, and VIII. When the determination result is negative, the correlation between R^{→} and (p₁^{→}+p₂^{→}) is negative, and the received signal R^{→} is in any one of the regions IV to VII. This is the same as to approximately calculate θ using Expression 35 (resolution 8).

In this way, the determining circuit 611 can find θ, and thus it is possible to determine what information is transmitted using the above-mentioned method. In this circuit, even when there is a difference between in the time standards between the transmitting and receiving devices or a frequency varies due to the Doppler effect, it is possible to correct the difference and the variation. When there is a difference in the time standards between the transmitting and receiving devices or a frequency varies due to the Doppler effect, R^{→} stops at two points that are symmetrical with respect to the origin O on the signal plane shown in FIG. 9B. When there is an error, the received signal R^{→} moves (rotates) in the signal plane shown in FIG. 9B. If the error is within an allowable range, it is possible to accurately demodulate the received information by including adjacent regions. That is, for example, when a signal Rᵢ^{→} that is being currently received is in the region I, the next received signal Rᵢ₊₁^{→} appears two regions adjacent to the region I, that is, the regions II and VIII, or three regions IV to VI that are symmetrical to the region I with respect to the origin O. In this way, it is determined whether Rᵢ^{→} is equal to Rᵢ₊₁^{→}, thereby determining whether the received bit is 1 or 0.

According to the above-mentioned structure of this embodiment, it is possible to achieve a receiving device having a simple comparing circuit (which may be considered as a 1-bit AD conversion circuit) without using a complicated circuit, such as a high-precision AD conversion circuit. The operating speed of the AD conversion circuit should be higher than a data transfer rate. Therefore, this embodiment that does not require the AD conversion circuit is particularly effective for a data transfer rate that is higher than 1 Gbps (gigabit per second). In addition, it is possible to perform synchronous detection without executing the synchronization between a received signal and a template vector and synchronization tracking. Therefore, it is possible to achieve a high-precision UWB-IR receiving device with a simple structure.

### Fourth Embodiment

In the third embodiment, when Rᵢ₊₁^{→} is received in the region III or VII, the determination process may not be performed since an error is excessively large. In the third embodiment, the comparing circuits 609 and 610 and the correlation circuits 613 and 614 can be considered as 1-bit AD conversion circuits. In order to reduce the region in which the determination process cannot be performed, the number of AD conversion bits of each of the comparing circuits may be increased by one bit to form 2-bit AD conversion circuits, which makes it possible to more accurately calculate θ in Expression 35. In this case, even when the transmitter side uses two template vectors to transmit 2-bit information for each symbol (when the transmitting device shown in FIG. 3C is used), it is possible to demodulate the information.

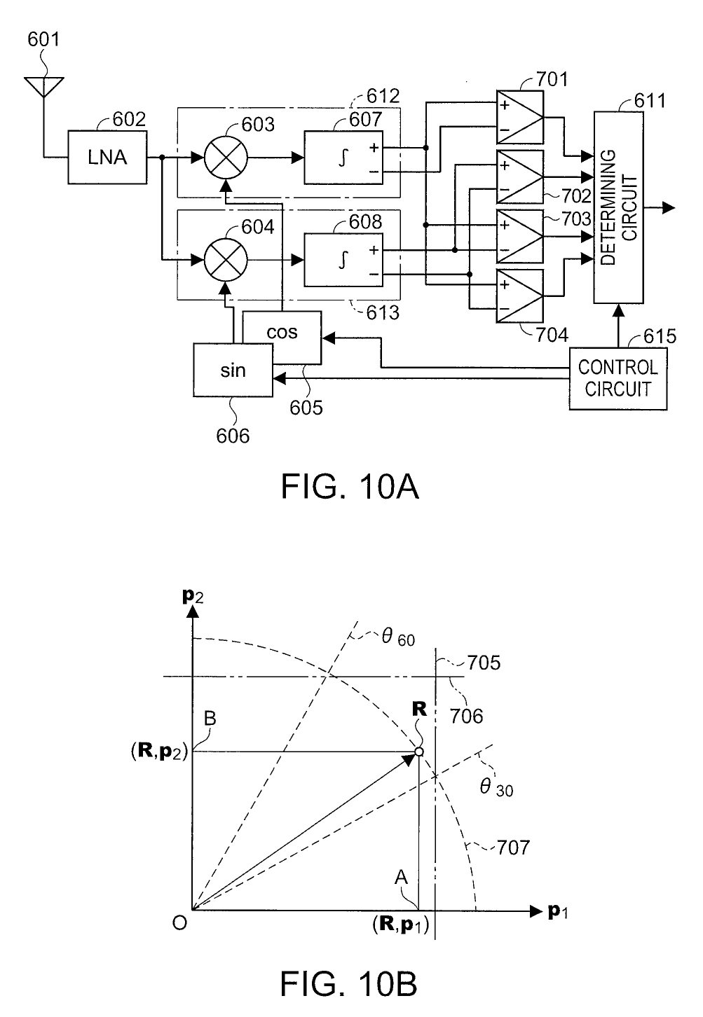

FIG. 10A is a block diagram illustrating the structure of a receiving unit in which the comparing circuits 609, 610, 613, and 614 are replaced with 2-bit AD conversion circuits 701 to 704. For clarity of description, In FIG. 10A, blocks having the same functions as those in FIG. 9A are denoted by the same reference numerals. The determining circuit 611 calculates θ from the conversion results of the AD conversion circuits using Expression 35, and determines received data.

FIG. 10B is a constellation diagram, and shows only the first quadrant for simplicity of description. The received signal vector R^{→} moves on an arch 707 having the origin O as its center due to a difference between the time standards of the transmitter and receiver sides or the Doppler effect. The 2-bit AD conversion circuit 701 performs 2-bit AD conversion to determine whether the correlation between R^{→} and pᵢ^{→} is negative or positive or whether the absolute value thereof is larger than |R^{→} cos 30°. In this case, |R^{→}| indicates the absolute value (length) of R^{→} and is calculated from the correlations between R^{→}, and p and p₂^{→} by ((R^{→}, p₁^{→})²+(R^{→}, p₂^{→})²)^{1/2}.

In FIG. 10B, when an intersection point between the perpendicular line from R^{→} to a p₁^{→} axis and the p₁^{→} axis is referred to as A, the length of a segment OA indicates (R^{→}, pᵢ^{→}). A perpendicular line 705 from an intersection point between a straight line θ₃₀ that it tilted at an angle of 30° with respect to pᵢ^{→} and the arc 707 to the pᵢ^{→} axis is the boundary that the value of (R^{→}, p₁^{→}) is larger than or lower than ±|R^{→}|cos 30°. That is, when the most significant bit of the 2-bit AD conversion circuit 701 is used to determine the symbol of (R^{→}, p₁^{→}) and the determined level of the least significant bit thereof is used as the boundary, it is determined whether the correlation value between R^{→} and p₁^{→} is within the range of ±|R^{→}|cos 30°.

Further, in FIG. 10B, when an intersection point between the perpendicular line from R^{→} to a p₂^{→} axis and the p₂^{→} axis is referred to as B, the length of a segment OB indicates (R^{→}, p₂^{→}). A perpendicular line 706 from an intersection point between a straight line θ₆₀ that it tilted at an angle of 30° with respect to p₂^{→} and the arc 707 to the p₂^{→} axis is the boundary that the value of (R^{→}, p₂^{→}) is larger than or lower than |R^{→}|cos 30°. That is, when the most significant bit of the 2-bit AD conversion circuit 702 is used to determine the symbol of (R^{→}, p₂^{→}) and the determined level of the least significant bit thereof is used as the boundary, it is determined whether the correlation value between R^{→} and p₂^{→} is within the range of +R^{→} cos 30°.

As described above, finally, it is possible to divide the signal vector plane into 12 regions at angular intervals of 30°. In this way, even when the transmitter side uses two template vectors e₁^{→} and e₂^{→} to transmit 2-bit information for each symbol, it is possible to demodulate the information. Even when R^{→} moves in the signal vector plane due to a difference between the time standards of the transmitter and receiver sides or an error caused by a frequency shift of the Doppler effect, it is possible to demodulate the received signal as long as it can move in one adjacent block (±30°).

Similarly, the 2-bit AD conversion circuits 703 and 704 can divide a signal space at angular intervals of 30°. The signal space is divided on the basis of p₁^{→}+p₂^{→} and p₁^{→}−p₂^{→}, not p₁^{→} and p₂^{→}. Therefore, the signal space is divided at angular intervals of 30° while being inclined 45°, and finally, it is divided into 24 regions at angular intervals of 15°. As a result, it is possible to calculate the accurate position of R^{→} or θ using Expression 35. In this way, it is possible to increase the allowable value of a difference between the time standards of the transmitter and receiver sides or an error caused by a frequency shift of the Doppler effect.

According to the above-mentioned structure of this embodiment, it is possible to achieve a receiving device having a simple and low-resolution (2-bit) AD conversion circuit without using a complicated circuit, such as a high-precision AD conversion circuit. The operating speed of the high-precision AD conversion circuit should be higher than a data transfer rate. Therefore, this embodiment that does not require the AD conversion circuit is particularly effective for a data transfer rate that is higher than 1 Gbps (gigabit per second). In addition, it is possible to perform synchronous detection without executing the synchronization between a received signal and template vector and synchronization tracking. Therefore, it is possible to achieve a high-precision UWB-IR receiving device with a simple structure.

### Fifth Embodiment

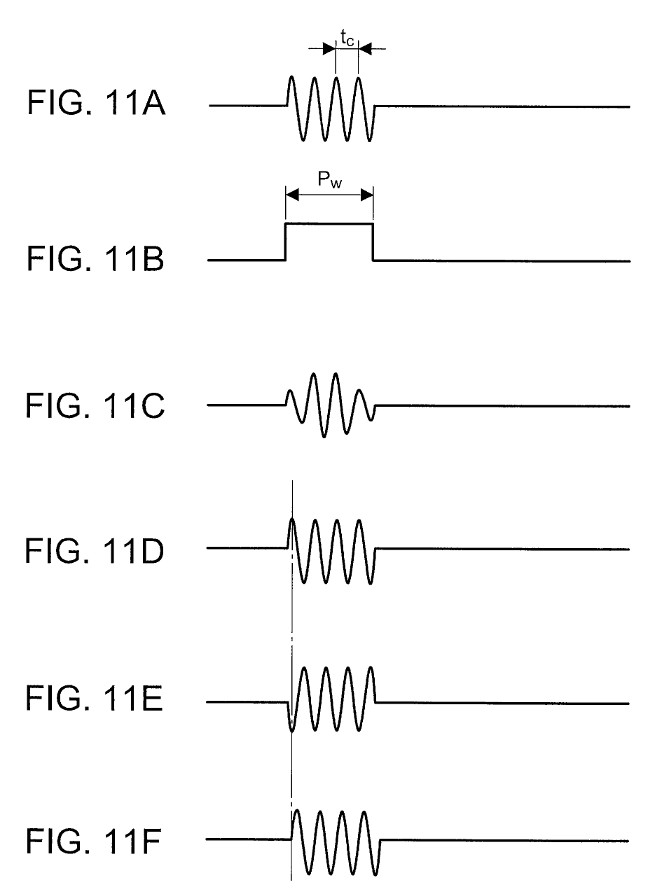

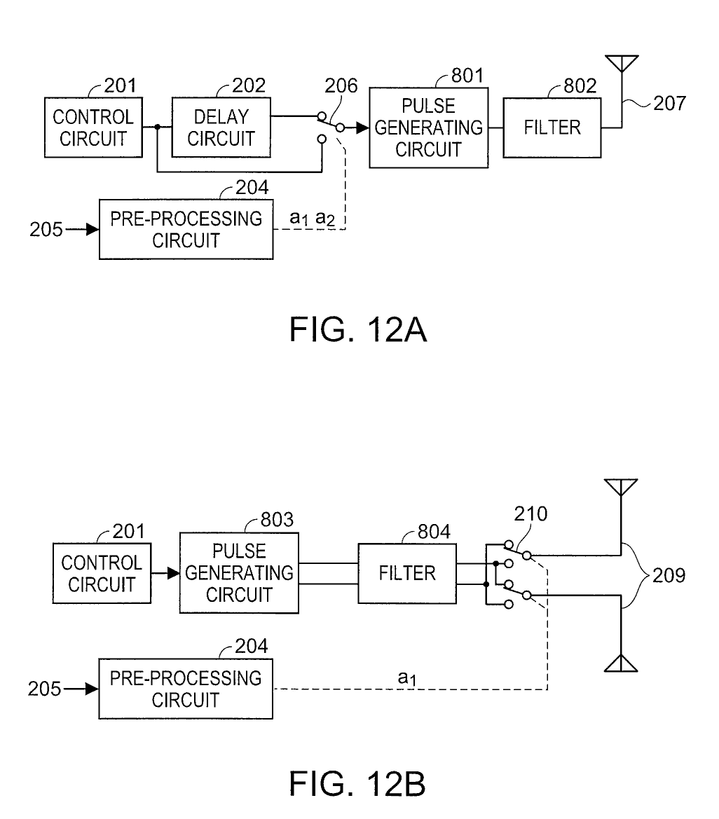

FIGS. 11A to 11F and FIGS. 12A and 12B are diagrams illustrating pulse waveforms used in a UWB communication device according to a fifth embodiment of the invention. FIG. 11A is a diagram illustrating a basic waveform. The waveform can be generated by cutting a sine wave having a period to using a rectangular window having a width P_{w} shown in FIG. 11B. As compared to the Gaussian pulse, the waveform has a large side lobe in a frequency domain and is widely spread. However, the waveform has been generally used since it is easy to generate. It is possible to practically use this waveform by restricting the side lobe by a filtering process and making the envelope of the waveform round as shown in FIG. 11C.

A transmitting device can be configured using the modulation described in the first embodiment. That is, the following can be used: the BPM system in which the pulse shown in FIG. 11A is used as the template vector e₁^{→} (see FIG. 11D) of the transmitter side, and an inverted waveform (see FIG. 11E) of the pulse is used as information to be transmitted; or the PPM system in which the information to be transmitted is delayed by a predetermined amount of time, ideally, tc/4 and a pulse (see FIG. 11F) having the same polarity is used as the second template signal e₂^{→} of the transmitter side. Alternatively, BPM may be performed on e₁^{→} and e₂^{→} to transmit 2-bit information for each symbol.

FIG. 12A is a block diagram illustrating the structure of the PPM transmission device. In FIG. 12A, blocks having the same functions as those of the transmitting device shown in FIGS. 3A to 3C are denoted by the same reference numerals, and a description thereof will be omitted. A pulse generating circuit 801 generates the pulse shown in FIG. 11A. The position where the pulse generating circuit 801 generates the pulse is changed according to whether a pulse start instruction is input to the pulse generating circuit directly or through a delay circuit 202, by information of a signal to be transmitted. The side lobe of the pulse generated by the pulse generating circuit 801 is limited by a filter 802, and the pulse is processed into a pulse having a round envelope shown in FIG. 11B. Then, the pulse is radiated by an antenna 207.

FIG. 12B is a block diagram illustrating the structure of the BPM transmission device. In FIG. 12B, blocks having the same functions as those of the transmitting device shown in FIGS. 3A to 3C are denoted by the same reference numerals, and a description thereof will be omitted. A pulse generating circuit 803 outputs a differential signal for generating the pulse shown in FIG. 11A. The side lobe of the pulse generated by the pulse generating circuit 803 is limited by a filter 804, and the pulse is processed into a pulse having the round envelope shown in FIG. 11B. Then, the polarity of the pulse is reversed by the switch 210 according to the information of the signal to be transmitted and then the pulse is radiated by the antenna 209. The switch 210 may be provided immediately after the pulse generating circuit 803 to modulate a signal (switch the polarity of the signal) and then transmit the signal to the antenna 209 through the filter 804.

The above structure may be applied to a transmitting device that performs BPM on e₁^{→} and e₂^{→} to transmit 2-bit information for each symbol, and thus a description thereof will be omitted.

When the receiver side uses the sine waves defined by Expressions 25 and 26 as the template vectors p₁^{→} and p₂^{→}, it is possible to perform demodulation using the same method as that used in the first embodiment. However, the frequency fp of the sine wave is 1/tc.

As described above, according to the structure of the UWB receiving device, a synchronous receiving device can perform synchronous detection, without executing high-precision synchronization acquisition or synchronization tracking. In this embodiment, particularly, it is easy to generate a template pulse used for IR communication, and it is possible to reduce the load of circuits of the transmitting and receiving devices.

### Sixth Embodiment

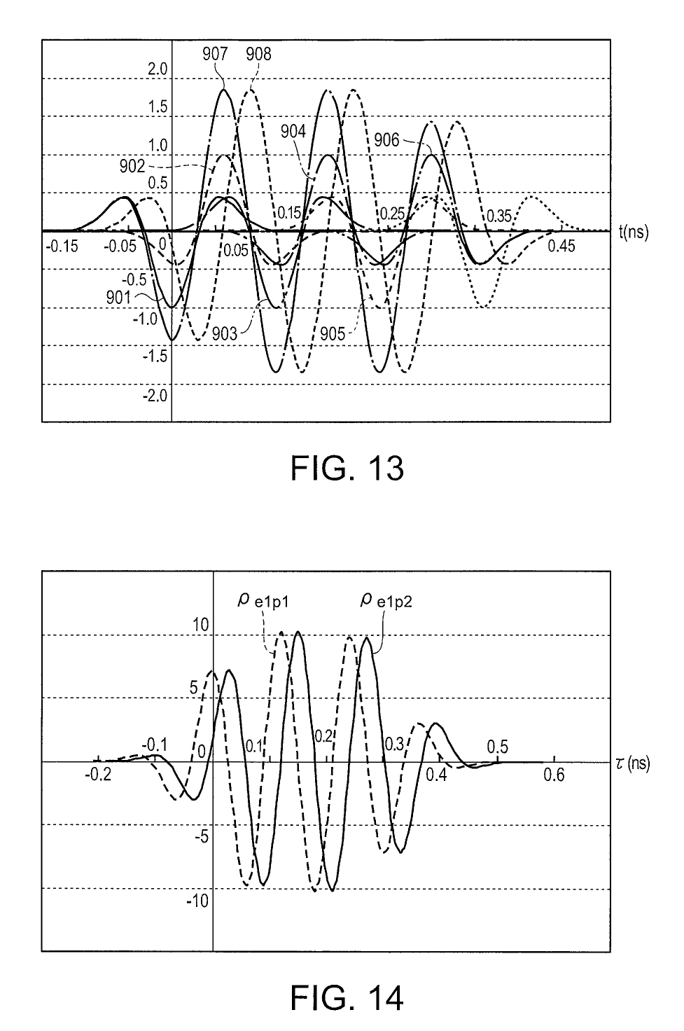

FIG. 13 is a diagram illustrating template vector signals of a receiver side according a sixth embodiment of the invention. In this embodiment, a waveform that is obtained by reversing the polarity of the template pulse of the transmitter side and adding the reverse pulses arranged at equal intervals of time is used. For example, in this embodiment, the second-order differential waveform of the Gaussian pulse used in the first embodiment is used, but the invention is not limited thereto.

A waveform 901 is the second-order differential waveform of the Gaussian pulse. In the first embodiment, the waveform is used as the template vector e₁^{→} of the transmitter side. The polarity of this waveform is reversed and arranged at equal intervals of time to obtain waveforms 902, 903, 904, 905, and 906. This time interval is preferably half the period of a peak frequency of the pulse spectrum, that is, half of t₀/1.414. Since this pulse is a short pulse, high accuracy in the time axis direction is not required. In this case, to is a constant that determines the pulse width of the Gaussian pulse defined by Expression 19. These waveforms are added to obtain a waveform 907. In FIG. 13, for example, to is 0.2 ns (fp=5 GHz). In this embodiment, this waveform is used as the template vector p₁^{→} of the receiver side. In addition, pᵢ^{→} is shifted in the time axis direction to obtain a waveform 908. This waveform is used as a template vector p₂^{→}. When the amount of time shift is a quarter of t₀/1.414, p₁^{→} can be orthogonal to p₂^{→}. Therefore, the above value is preferable. As described with reference to FIGS. 8A to 8C, only when there is a received pulse signal, the template vector is effective. Therefore, the number of pulses arranged is preferably as small as possible (a set of negative and positive pulses), as long as the overlap between the pulse signal and the template vector can be ensured at all times. At the beginning of the establishment of communication, the number of pulses arranged may be increased in order to search signal timing, thereby using a template vector having a large width.

FIG. 14 is a diagram illustrating a cross correlation function between the template vector p₁^{→} of the receiver side shown in FIG. 13 and the template vector e₁^{→} (which is the same as the waveform 901 shown in FIG. 13) of the transmitter side. In addition, FIG. 14 shows a cross correlation function ρₑ₁ₚ₁ between p₁^{→} and e₁^{→}. A cross correlation function ρₑ₁ₚ₂ between p₂^{→} and e₁^{→} can be directly calculated by time shift since p₂^{→} is just shifted from p₁^{→} in the time axis direction.

As described above, since the cross correlation functions are known, it is possible to accurately demodulate the received signal using Expressions 21 to 24 when any time relationship is established between the received signal and the template vectors p₁^{→} and p₂^{→} of the receiver side. It is possible to plot the received signal R^{→} in a 2-dimensional partial space including p₁^{→} and p₂^{→}. That is, the following Expression 35 is obtained by Expressions 4, 21, and 22.

R^{→}=c₁p₁^{→}+c₂p₂^{→} (35)

Therefore, c^{→}=(c₁ c₂) is coordinates that indicate the position of R^{→} in the plane having p₁^{→} and p₂^{→} as axes.

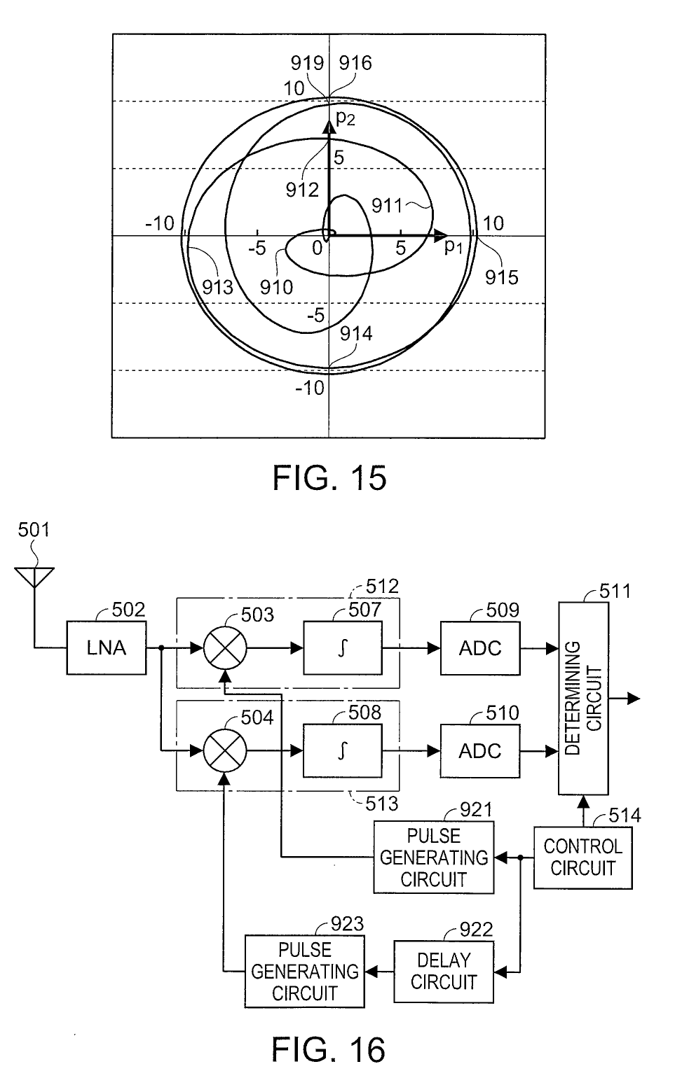

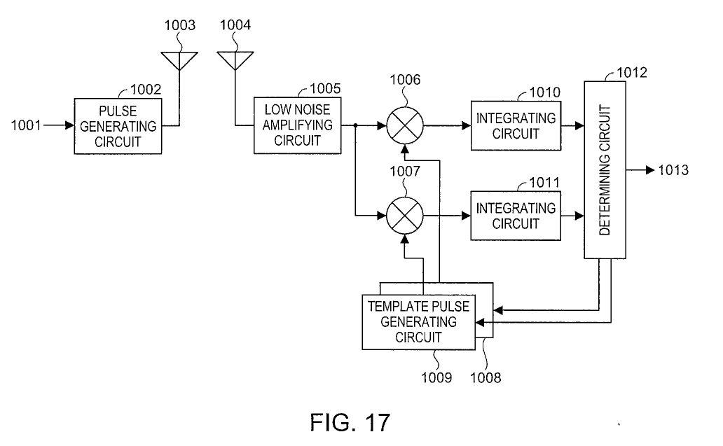

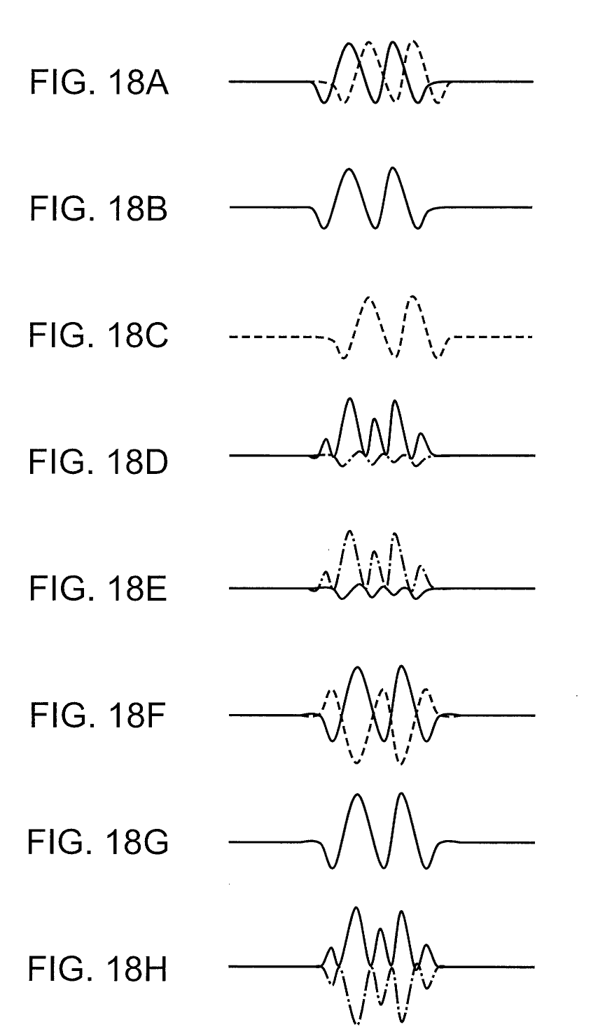

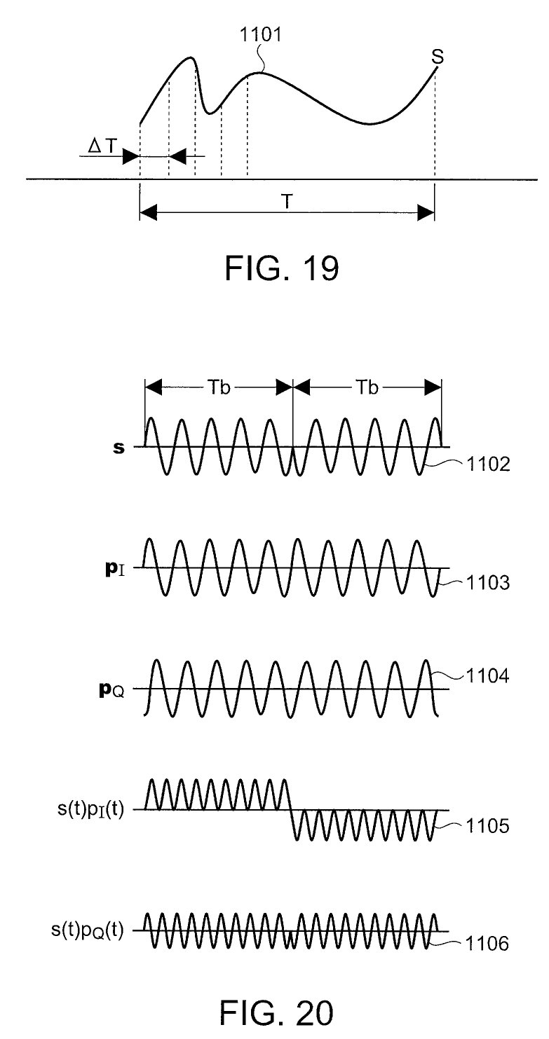

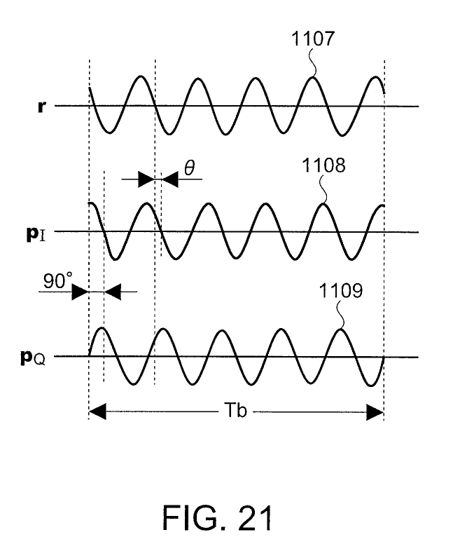

This aspect will be described below with reference to FIG. 15. FIG. 15 is a diagram plotting the locus of c^{→} on a plane having p₁^{→} and p₂^{→} as the horizontal axis and the vertical axis, respectively. First, a case in which a^{→}=(1 0) in Expressions 21 and 22 will be described. In this case, c=(ρₑ₁ₚ₁(τ) ρₑ₁ₚ₂(τ)) is obtained by Expression 23. When τ=−∞, both the correlation between R^{→} and p₁^{→} and the correlation between R^{→} and p₂^{→} are zero. Therefore, R^{→} is plotted to the origin. When R^{→} is gradually shifted in the positive direction of the time τ and is disposed in the vicinity of τ=−0.05, c1, that is, the correlation value ρₑ₁ₚ₁(τ) between R^{→} and p₁^{→} is the minimum value, and R^{→} is plotted in the vicinity of a point 910 shown in FIG. 15. Then, when τ=0, c1 (that is, ρₑ₁ₚ₂(τ)) is the maximum value, R^{→} is plotted in the vicinity of a point 911. When 0≦τ≦0.3 and the correlation value ρₑ₁ₚ₁(τ) is the minimum value or the maximum value, the correlation value Pₑ₁ₚ₂(τ) is approximately zero. On the other hand, the correlation value Pₑ₁ₚ₂(τ) is the minimum value or the maximum value, the correlation value ρₑ₁ₚ₁(τ) is approximately zero. Therefore, R^{→} moves in the order of the points 912, 913, 914, 915, 916, . . . , 919, and finally reaches the origin.

Next, a case in which a^{→}=(0 1) in Expressions 21 and 22 will be described. In this case, since p₂^{→} is just shifted from p₁^{→ in the time axis direction, R}^{→} moves along the same locus as described above. The influence of the time shift appears as a phase difference in FIG. 15. A phase difference between a^{→}=(1 0) and a^{→}=(0 1) is 90°. In the modulated state, the two vectors are linearly combined by Expressions 21 and 22, and R^{→} is plotted on the plane as the sum of the vectors at four points that are separated from each other at an angular interval of 900 by the modulated information.

In the range of 0.05<τ<0.25 where the maximum and minimum values are substantially equal to each other, R→moves substantially on the circumference, like the points 913 to 919. When R^{→} is received in this range, it is possible to maintain a good reception condition. When it is difficult to predict the time when the next pulse is received at the beginning of the reception of signals or when a large error occurs due to a difference between the time standards of the transmitting and receiving devices or the Doppler effect, it is preferable to increase the number of pulses that are repeatedly added as shown in FIG. 13 such that the period for which the minimum value and the maximum value are substantially equal to each other is lengthened. When it is possible to predict the time when the next pulse is received, the number of pulses that are repeatedly added may be reduced to stop the operation of the pulse generating circuit of the receiving device, thereby reducing the power consumption of the receiving device.

FIG. 16 is a block diagram illustrating an example of the structure of the receiving device according to this embodiment. In FIG. 16, blocks having the same functions as those in FIG. 8A are denoted by the same reference numerals, and a description thereof will be omitted. A pulse generating circuit 921 generates the template pulse (waveform) 907 (p₁^{→}) shown in FIG. 13, and includes a circuit that gradually generates a pulse while reversing the polarity of the second-order differential waveform of the Gaussian pulse and an adding circuit. A pulse generating circuit 923 generates the template pulse (waveform) 908 (p₂^{→}), and includes a circuit that gradually generates a pulse while reversing the polarity of the second-order differential waveform of the Gaussian pulse and an adding circuit. The pulse generating circuit 923 is operated after a predetermined time is delayed by a delay circuit 922 after the start of p₁^{→}. A demodulating process of the receiving device is performed by Expression 24, and has been described in detail above. In this embodiment, demodulation can be performed by the same structure and operation as described above.

In this embodiment, even when a pulse whose autocorrelation is not zero in an overlap state, such as the Gaussian pulse, is used as the template vector {eᵢ^{→}} of the transmitter side, it is possible to distribute the constellation of the received signal on an m-dimensional hypersphere in an m-dimensional space including {pᵢ^{→}} at an equal distance by setting the template vector {pᵢ^{→}} of the receiver side in the above-mentioned range. In this way, it is possible to accurately perform the demodulating operation of the receiving device.

As described above, the UWB receiving device does not need to accurately perform synchronization between the received pulse and the receiving device. As a result, it is possible to simplify the structure of a receiving device.

In the above-described embodiments of the invention, real vectors are used to easily to calculate vectors, but the invention is not limited thereto. Complex vectors may be used. The invention is not limited to a model using the real vectors, but a model using complex vectors may be used, if necessary.

In many cases, the above-described embodiments can easily calculate or predict vectors, and are very useful. In order to actually apply the model using complex vectors to a circuit or a device, one of or both a real part and an imaginary part may be used.

Further, in the above embodiments of the invention, the receiving device used in the UWB communication using pulses has been described, but the invention is not limited thereto. In particular, when the template vector {pᵢ^{→}} of the receiver side is considered as a code of a code division multiple access system, it is possible to configure a receiving device for carrier communication using the same structure and operation as described above.

The entire disclosure of Japanese Patent Application No. 2007-250777, filed Sep. 27, 2007 is expressly incorporated by reference herein.

What is claimed is:

1. A receiving device that receives as a received signal R^{→} a transmission signal T^{→} (T^{→}=a₁e₁^{→}+a₂e₂^{→}+ . . . +aₖeₖ^{→}) obtained by multiplying k (k is a positive integer) linear independent signal vectors {eᵢ^{→}|i is an integer satisfying 1≦i≦k} by a transmission information coefficient {ai|i is an integer satisfying 1≦i≦k and ai is a real number}, the receiving device comprising:
a template generating unit that generates m (m is a positive integer) linear independent template vectors {pᵢ^{→}|1≦i≦m};
a correlation unit that calculates a correlation value {cᵢ=(R^{→}, pᵢ^{→})|1≦i≦m} between the received signal R^{→} and the template vector {pᵢ^{→}} and outputs a correlation value vector c^{→} (c₁, c₂, . . . , cₘ); and
a multiplying unit that multiplies a transposed matrix of a matrix [ρ_{τ}] by the correlation value vector c^{→},
wherein the matrix [ρ_{τ}] converts a matrix [p] of the m template vectors {pᵢ^{→}} into a matrix [e_{τ}] of signal vectors {e_{iτ}^{→}|1≦i≦m} that are obtained by shifting m signal vectors {eᵢ^{→}|1≦i≦m}, which are obtained by adding (m−k) linear independent signal vectors {eᵢ^{→}|k+1≦i≦m} to the signal vectors {eᵢ^{→}}, by a time τ.

2. A receiving device that receives as a received signal Rⱼ^{→} a series of transmission signals Tⱼ^{→} (Tⱼ^{→}=aⱼe₁^{→}+a₂ⱼe₂^{→}+ . . . +aₖⱼeₖ^{→}) obtained by multiplying k (k is a positive integer) linear independent signal vectors {eᵢ^{→}|i is an integer satisfying 1≦i≦k} by a transmission information coefficient {aᵢⱼ|i is an integer satisfying 1≦i≦k, j is an integer, and aᵢⱼ is a real number}, the receiving device comprising:
a template generating unit that generates m (m is a positive integer) linear independent template vectors {pᵢ^{→}|1≦i≦m};
a correlation unit that calculates a correlation value {cᵢⱼ=(Rⱼ^{→}, pᵢ^{→})|1≦i≦m} between the received signal Rⱼ^{→} and the template vector {pᵢ^{→}} and outputs a series of correlation value vectors cⱼ^{→} (c₁ⱼ, c₂ⱼ, . . . cₘⱼ); and
a multiplying unit that multiplies a transposed matrix of a matrix [ρ] by a difference (cⱼ^{→}−cⱼ₋₁^{→}) between the correlation value vector cⱼ^{→} (c₁ⱼ, c₂ⱼ, . . . , cₘⱼ) and the previous correlation value vector cⱼ₋₁^{→},
wherein the matrix [ρ] converts a matrix [p] of the m template vectors {pᵢ^{→}} into a matrix [e] of signal vectors that are obtained by adding (m−k) linear independent signal vectors {eᵢ^{→}|k+1≦i≦m} to the signal vector {eᵢ^{→}}.

3. The receiving device according to claim 1,
wherein the signal vector {eᵢ^{→}} is any one of a Gaussian pulse, an n-order differential pulse of the Gaussian pulse, a Hermite pulse, a modified Hermite pulse, and a pulse obtained by shaping a sine wave using a window function.

4. The receiving device according to claim 2,
wherein the signal vector {eᵢ^{→}} is any one of a Gaussian pulse, an n-order differential pulse of the Gaussian pulse, a Hermite pulse, a modified Hermite pulse, and a pulse obtained by shaping a sine wave using a window function.

5. The receiving device according to claim 1,
wherein the template vector {pᵢ^{→}} includes a plurality of linear independent sine waves.

6. The receiving device according to claim 2,
wherein the template vector {pᵢ^{→}} includes a plurality of linear independent sine waves.

7. The receiving device according to claim 1,
wherein the template vector {pᵢ^{→}} is formed by shaping a plurality of linear independent sine waves using a variable-length window function.

8. The receiving device according to claim 2,
wherein the template vector {pᵢ^{→}} is formed by shaping a plurality of linear independent sine waves using a variable-length window function.

9. The receiving device according to claim 1,
wherein the template vector {pᵢ^{→}} is formed by reversing the polarity of the signal vector {eᵢ^{→}} and arranging it at equal intervals of time.

10. The receiving device according to claim 2,
wherein the template vector {pᵢ^{→}} is formed by reversing the polarity of the signal vector {eᵢ^{→}} and arranging it at equal intervals of time.

11. The receiving device according to claim 1,
wherein k=1 or 2, and m=2,
the multiplying unit includes:
a first comparing circuit that determines whether the correlation value c₁ is positive or negative;
a second comparing circuit that determines whether the correlation value c₂ is positive or negative;
a third comparing circuit that determines whether the correlation value c₁+c₂ is positive or negative; and
a fourth comparing circuit that determines whether the correlation value c₁-c₂ is positive or negative, and
the multiplying unit divides a plane including the template vectors p₁→ and p₂→ into eight regions, determines which of the regions includes the received signal R^{→}, and performs the multiplication on the basis of the determination result.

12. The receiving device according to claim 2,
wherein k=1 or 2, and m=2,
the multiplying unit includes:
a first comparing circuit that determines whether the correlation value c₁ⱼ is positive or negative;
a second comparing circuit that determines whether the correlation value c₂j is positive or negative;
a third comparing circuit that determines whether the correlation value c₁ⱼ+c₂ⱼ is positive or negative; and
a fourth comparing circuit that determines whether the correlation value c₁ⱼ−c₂j is positive or negative, and
the multiplying unit divides a plane including the template vectors p₁^{→} and p₂^{→} into eight regions, determines which of the regions includes the received signal Rⱼ^{→}, and performs the multiplication on the basis of the determination result.

13. The receiving device according to claim 1,
wherein k=1 or 2, and m=2,
the multiplying unit includes:
a first 2-bit AD conversion circuit that performs AD conversion on the correlation value c₁; and
a second 2-bit AD conversion circuit that performs AD conversion on the correlation value c₂, and
the multiplying unit divides a plane including the template vectors p₁→ and p₂→ into twelve regions, determines which of the regions includes the received signal R^{→}, and performs the multiplication on the basis of the determination result.

14. The receiving device according to claim 2,
wherein k=1 or 2, and m=2,
the multiplying unit includes:
a first 2-bit AD conversion circuit that performs AD conversion on the correlation value c₁ⱼ; and
a second 2-bit AD conversion circuit that performs AD conversion on the correlation value c₂j, and
the multiplying unit divides a plane including the template vectors p₁^{→} and p₂^{→} into twelve regions, determines which of the regions includes the received signal Rⱼ^{→}, and performs the multiplication on the basis of the determination result.

15. The receiving device according to claim 1,
wherein k=1 or 2, and m=2,
the multiplying unit includes:
a first 2-bit AD conversion circuit that performs AD conversion on the correlation value c₁;
a second 2-bit AD conversion circuit that performs AD conversion on the correlation value c₂;
a third 2-bit AD conversion circuit that performs AD conversion on the correlation value c₁+c₂; and
a fourth 2-bit AD conversion circuit that performs AD conversion on the correlation value c₁-c₂, and
the multiplying unit divides a plane including the template vectors p₁^{→} and p₂^{→} into twenty four regions, determines which of the regions includes the received signal R^{→}, and performs the multiplication on the basis of the determination result.

16. The receiving device according to claim 2,
wherein k=1 or 2, and m=2,
the multiplying unit includes:
a first 2-bit AD conversion circuit that performs AD conversion on the correlation value c₁ⱼ;
a second 2-bit AD conversion circuit that performs AD conversion on the correlation value c₂j;
a third 2-bit AD conversion circuit that performs AD conversion on the correlation value c₁ⱼ+c₂ⱼ; and
a fourth 2-bit AD conversion circuit that performs AD conversion on the correlation value c₁ⱼ-c₂ⱼ, and
the multiplying unit divides a plane including the template vectors p₁→ and p₂→ into twenty four regions, determines which of the regions includes the received signal Rⱼ^{→}, and performs the multiplication on the basis of the determination result.

17. The receiving device according to claim 1,
wherein the transmission information coefficient a₁ that is transmitted at the beginning of a unit of communication is fixed to predetermined bit information.

18. The receiving device according to claim 1,
wherein demodulation is continuously performed, assuming that the transmission information coefficient a₁ that is transmitted at the beginning of a unit of communication is fixed to predetermined bit information, to accurately correct and demodulate the transmission information coefficient {aⱼ} from redundancy included in the transmission information coefficient {aⱼ} that is transmitted for each unit of communication.

19. A receiving method of receiving as a received signal R^{→} a transmission signal T^{→} (T^{→}=a₁e₁^{→}+a₂e₂^{→}+ . . . +aₖeₖ^{→}) obtained by multiplying k (k is a positive integer) linear independent signal vectors {eᵢ^{→}|i is an integer satisfying 1≦i≦k} by a transmission information coefficient {ai|i is an integer satisfying 1≦i≦k and ai is a real number}, the receiving method comprising:
generating m (m is a positive integer) linear independent template vectors {pᵢ^{→}|1≦i≦m};
calculating a correlation value {ci=(R^{→}, pᵢ^{→}) 1≦i≦m} between the received signal R^{→} and the template vector {pᵢ^{→}} and outputting a correlation value vector c^{→} (c₁, c₂, cₘ); and
multiplying a transposed matrix of a matrix [ρ_{τ}] by the correlation value vector c^{→},
wherein the matrix [ρ_{τ}] converts a matrix [p] of the m template vectors {pᵢ^{→}} into a matrix [e_{τ}] of signal vectors {e_{iτ|}1≦i≦m} that are obtained by shifting m signal vectors {eᵢ^{→}|1≦i≦m}, which are obtained by adding (m−k) linear independent signal vectors {eᵢ^{→}|k+1≦i≦m} to the signal vectors {eᵢ^{→}}, by a time T.

20. A receiving method of receiving as a received signal Rⱼ^{→} a series of transmission signals Tⱼ^{→} (Tⱼ^{→}=a₁ⱼe₁^{→}+a₂ⱼe₂^{→}+ . . . +aₖⱼeₖ^{→}) obtained by multiplying k (k is a positive integer) linear independent signal vectors {eᵢ^{→}|i is an integer satisfying 1≦i≦k} by a transmission information coefficient {aᵢⱼ|i is an integer satisfying 1≦i≦k, j is an integer, and aᵢⱼ is a real number}, the receiving method comprising:
generating m (m is a positive integer) linear independent template vectors {pᵢ^{→}|1≦i≦m};
calculating a correlation value {cᵢⱼ=(Rⱼ^{→}, pᵢ^{→})|1≦i≦m} between the received signal Rⱼ^{→} and the template vector {pᵢ^{→}} and outputting a series of correlation value vectors cⱼ^{→} (C₁ⱼ, c₂ⱼ, . . . cₘⱼ); and
multiplying a transposed matrix of a matrix [ρ] by a difference (cⱼ^{→}−cⱼ₋₁^{→}) between the correlation value vector cⱼ^{→} (c₁ⱼ, c₂ⱼ, . . . cₘⱼ) and the previous correlation value vector cⱼ₋₁^{→},
wherein the matrix [ρ] converts a matrix [p] of the m template vectors {pᵢ^{→}} into a matrix [e] of signal vectors that are obtained by adding (m−k) linear independent signal vectors {eᵢ^{→}|k+1≦i≦m} to the signal vector {eᵢ→}.
